(19) United States
(12) Patent Application Publication
(10) Pub. No.: US 2023/0059379 A1
(43) Pub. Date: Feb. 23, 2023

(54) METHOD OF COMPUTER SIMULATION

(71) Applicant: Rohm Co., Ltd., Kyoto (JP)

(72) Inventor: Noriaki Hiraga, Kyoto (JP)

(21) Appl. No.: 17/797,263

(22) PCT Filed: Jan. 29, 2021
(86) PCT No.: PCT/JP2021/003255

§ 371 Date: Aug. 3, 2022

(30) Foreign Application Priority Data
Feb. 4, 2020 (JP) 2020017426

(51) Int. Cl. G01R 31/00; G06F 30/20

(52) U.S. Cl. CPC G01R 31/006; G01R 31/001; G06F 30/20

(57) ABSTRACT

A method of computer simulation is for evaluating the immunity characteristics of a device-under-test by use of a transmission line model that models a transmission line connected to the device-under-test. The method includes a characteristic change node at which parameters representing the transmission characteristics of the transmission line change midway.

### TECHNICAL FIELD

The invention disclosed herein relates to a method of computer simulation for evaluation of immunity characteristics.

### BACKGROUND ART

Conventionally, in the designing of structures (vehicles, railway cars, marine vessels, aircraft, and the like) that have transmission lines such as conductive wire harnesses, or in the designing of various kinds of electric components incorporated in such structures, as a means for evaluating their immunity characteristics or emission characteristics, a wide use is made of, other than measured benchmarks, EMC (electro-magnetic compatibility) computer simulations.

Examples of conventional technologies related to what has just mentioned are seen in Patent Documents 1 and 2, by the present applicant, in Patent Document 3, and in Non-Patent Document 1, all identified below.

### CITATION LIST

### Patent Literature

Patent Document 1: JP-A-2018-5831

Patent Document 2: JP-A-2015-75390

Patent Document 3: JP-A-2013-242649

### Non-Patent Literature

Non-Patent Document 1: H. Tanaka et al., “A Simulation Model of Bulk Current Injection (BCI) Test”, Technical Report, EMCJ, Environmental Electromagnetic Engineering, Institute of Electronics, Information and Communication Engineers (Japan), Aug. 31, 2012, Vol. 112, Issue 202, pp. 47-50.

### SUMMARY OF INVENTION

### Technical Problem

Inconveniently, in conventional EMC computer simulations, wire harness structures of measured benchmarks, which are subject to strict restrictions, are modeled as they are. For example, in a case where a measured benchmark prescribes that the total length of a wire harness be 1700 to 2000 mm and that EMC noise be injected at three positions (150 mm, 450 mm, and 570 mm from a DUT), also a wire harness structure of an EMC computer simulation is subject to restrictions equivalent to those on the measured benchmark. This results in insufficient coverage of phenomena that occur in reality, making it difficult to correctly evaluate actual immunity characteristics or emission characteristics.

Moreover, in conventional EMC computer simulations, a wire harness model is represented by a single characteristic impedance. This results in considerably large deviations between measured and simulated values.

Moreover, in conventional measured benchmarks and EMC computer simulations, a noise current is injected at one noise injection point, and a noise current is injected solely at a particular point on a simulated wire harness. However, for example, in a case where a vehicle is exposed to a thunderbolt, the entire wire harness network laid around the vehicle is interfered simultaneously. Thus, conventional measured benchmarks and EMC computer simulations with a single noise injection point simply serve as a means for checking characteristics in part; thus, those tests are necessary, to be sure, but are not simultaneously sufficient in evaluating the immunity characteristics of vehicles and of electric components incorporated in them.

### Solution to Problem

In view of the above-mentioned challenges encountered by the present inventor, the present disclosure presents a method of computer simulation that permits correct evaluation of immunity characteristics or emission characteristics. The present disclosure also presents a method of creating a transmission line model that permits reduction of deviations between measured and simulated values. The present disclosure further presents a method of computer simulation that permits reproduction of an environment in which a transmission line network is interfered at multiple positions simultaneously.

According to one aspect of what is disclosed herein, a method of computer simulation is configured to give variable parameters to a transmission line model that models a transmission line to which a device-under-test is connected, and to evaluate the immunity characteristics or emission characteristics of the device-under-test while sweeping those parameters.

According to another aspect of what is disclosed herein, a method of creating a transmission line model for computer simulation is configured to include a step of classifying transmission lines to be modeled into at least two classes, namely an end line and a middle line, according to their arrangement, and a step of creating an end-line model and a middle-line model by separately modeling the end and middle lines.

According to another aspect of what is disclosed herein, a method of computer simulation is configured to evaluate the immunity characteristics of a device-under-test by use of a transmission line model that models a transmission line connected to the device-under-test, and to include a step of setting a plurality of noise injection points on the transmission line, and a step of injecting a noise signal at those noise injection points simultaneously.

According to another aspect of what is disclosed herein, a method of computer simulation is configured to evaluate the immunity characteristics of a device-under-test by use of a transmission line model that models a transmission line connected to the device-under-test, and the transmission line model includes a characteristic change node at which parameters that represent the transmission characteristics of the transmission line change midway.

According to another aspect of what is disclosed herein, a method of computer simulation is configured to include a step of determining at least one of a noise injection position or a noise strength on a transmission line based on the electromagnetic wave incidence direction with respect to a structure that incorporates the transmission line and three-dimensional data of each of the structure and the transmission line, and a step of evaluating the immunity characteristics of a device-under-test connected to the transmission line by use of a transmission line model that models the transmission line.

Other features, elements, steps, benefits, and characteristics of the present invention will become clear through the following detailed description of embodiments and the accompanying drawings associated therewith.

### Advantageous Effects of Invention

With a method of computer simulation disclosed herein, it is possible to correctly evaluate actual immunity characteristics or emission characteristics. With a method of creating a transmission line model disclosed herein, it is possible to create a transmission line model that can reduce deviations between measured and simulated values. With a method of computer simulation disclosed herein, it is possible to reproduce an environment in which a transmission line network is interfered at multiple positions simultaneously.

### BRIEF DESCRIPTION OF DRAWINGS

FIG. 1 is a schematic diagram of a wire harness network laid around a vehicle.

FIG. 2 is a block diagram showing one example of an electric component BCI test.

FIG. 3 is a block diagram showing one example of a vehicle BCI test.

FIG. 4 is a block diagram showing one example of an electrical component emission test.

FIG. 5 is a block diagram showing one example of a simulation model.

FIG. 6 is a diagram showing an example of a comparison of a malfunctioning voltage-frequency response with an arriving voltage-frequency response (solid line).

FIG. 7 is a sectional view schematically showing an example of wire arrangement in a wire harness

FIG. 8 is a frequency-gain diagram illustrating the arrangement position-dependence of transmission characteristics.

FIG. 9A is a sectional view schematically showing a single-line model.

FIG. 9B is a sectional view schematically showing an end-line model.

FIG. 9C is a sectional view schematically showing a middle-line model.

FIG. 10 is a measured waveform diagram characteristic impedance (CPAVS0.75f).

FIG. 11 is a measured waveform diagram characteristic impedance (IV8mm²LFV).

FIG. 12 is a table showing the values of parameters of transmission line models.

FIG. 13 is a schematic diagram showing examples of the description of a transmission line model.

FIG. 14 is a frequency-characteristic impedance diagram showing an example of reproduction by simulation.

FIG. 15 is a schematic diagram showing an example of changing the description of a transmission line model (when a noise injection point is added).

FIG. 16 is a schematic diagram showing an example of changing the description of a transmission line model (when a noise injection position is changed).

FIG. 17 is a schematic diagram showing an example of changing the description of a transmission line model (when the wire arrangement is changed).

FIG. 18 is a flow chart of a conventional method of EMC evaluation.

FIG. 18B is a flow chart of a new method of EMC evaluation.

FIG. 19 is a schematic diagram showing the sweeping ranges of parameters.

FIG. 20 is a schematic diagram showing a first example of a simultaneous multiple injection model.

FIG. 21 is a schematic diagram showing a second example of a simultaneous multiple injection model.

FIG. 22 is a schematic diagram showing a situation where a magnetic field is applied in the direction perpendicular to a wire loop.

FIG. 23 is a schematic diagram showing a situation where a magnetic field is applied in a direction oblique to a wire loop.

FIG. 24 is a schematic diagram showing the modeling of a wire laid near a good-conductor surface.

FIG. 25 is a schematic diagram showing the modeling of a wire harness with a bifurcated structure.

FIG. 26 is a diagram showing a noise injection position on a wire laid inside a structure.

FIG. 27 is a schematic diagram illustrating how different parts of a structure differ in immunity characteristics.

FIG. 28 is a schematic diagram showing a plurality of electromagnetic wave sources provided around a structure.

FIG. 29A is a schematic diagram showing a noise injection position with a first electromagnetic wave source selected.

FIG. 29B is a schematic diagram showing a noise injection position with a second electromagnetic wave source selected.

FIG. 30 is a flow chart showing one example of an omnidirectional simulation.

### DESCRIPTION OF EMBODIMENTS

<Wire Harness Network>

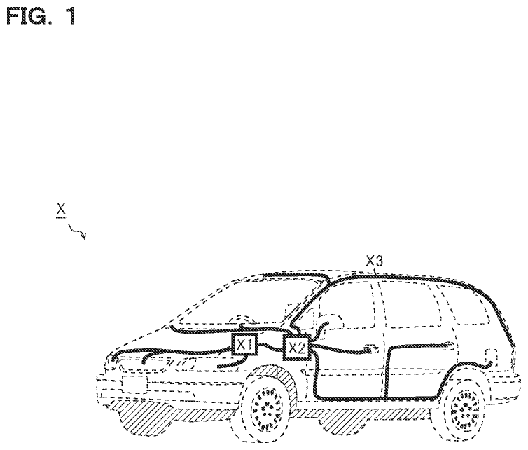

FIG. 1 is a schematic diagram of a wire harness network laid around a vehicle (i.e., a skeleton diagram of a vehicle). A vehicle X today is furnished with a variety of electric components (various lamps, various pumps, various fans, electronic suspension system, wipers, door locks, power windows, power side mirrors, and the like). Among these electric components as well as a battery X1 and an ECU (electronic control unit) X2, wire harnesses X3 are laid all around for transmission of electric power and signals. A vehicle X like this incorporating a number of electric components is subject to various immunity tests and emission tests with a view to increased safety and reliability.

Structures that have a wire harness network are not limited to vehicles, and include, other than vehicles, railway cars, marine vessels, aircraft, and the like.

<Electric Component BCI Test (ISO11452-4)>

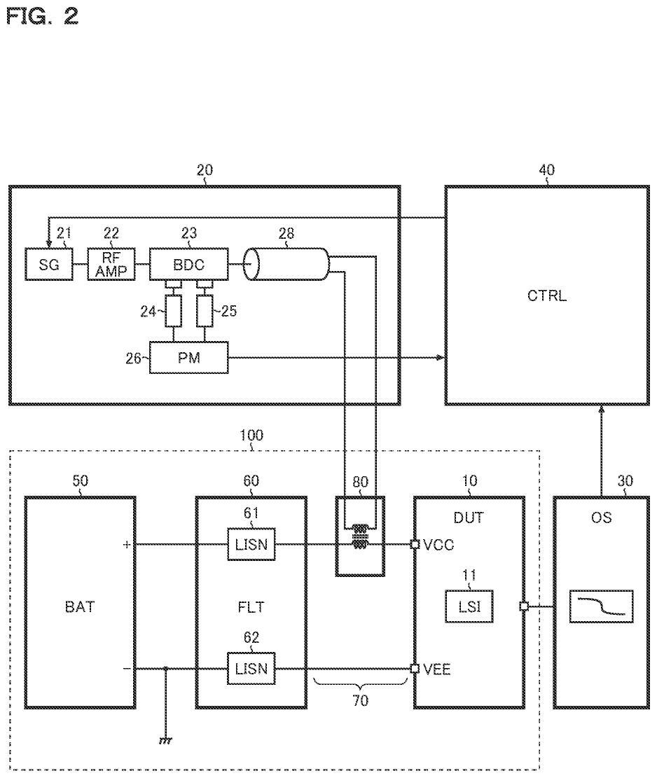

FIG. 2 is a block diagram showing one configuration example of an electric component BCI test. An electric component BCI test is a kind of immunity test complying with the “component test methods for electrical disturbances from narrowband radiated electromagnetic energy (ISO11452-4)” standardized by the International Organization for Standardization (ISO).

More specifically, in terms of what is shown in FIG. 2, an electric component BCI test is performed, as a measured benchmark for evaluating the immunity characteristics of a test target circuit unit 100 (or a unit simulating it), using a noise source 20, a detector 30, a controller 40, and an injection probe 80.

The test target circuit unit 100 corresponds to an actual product (real device) that incorporates a device-under-test 10 (hereinafter DUT). The test target circuit unit 100 includes, in addition to the DUT 10, a battery 50, a power filter 60, and a wire harness 70. The test target circuit unit 100 may also include a dummy load for the DUT 10.

The DUT 10 includes an LSI (large-scale integrated circuit) 11 and a printed circuit board (PCB) on which the LSI 11 is mounted. Needless to say, the LSI 11 on its own may be used as the DUT 10. Incidentally, the DUT 10 need not necessarily be a real device and is in general often substituted by a simulating device for testing.

In particular, in a case where a plurality of LSIs are compared with each other (e.g., a new-model LSI with an old-model LSI, or a manufacturer's own LSI with a competitor's compatible LSI), it is preferable to use a simulating device for testing that is standardized in all elements except the LSI as the evaluation target, i.e., in PCB size, wiring patterns, and the types and characteristics of discrete components mounted on the PCB.

The noise source 20 is the agent that injects a high-frequency noise signal (interfering electric power) at a terminal (in FIG. 2, exemplified by a power terminal VCC) of the DUT 10. The noise source 20 includes a signal generator 21, an RF amplifier 22, a bidirectional coupler 23, a traveling wave-side power sensor 24, a reflected wave-side power sensor 25, a power meter 26, and a 50Ω transmission line 28.

The signal generator (SG) 21 generates a high-frequency noise signal with a sinusoidal waveform. The signal generator 21 may modulate the high-frequency noise signal as necessary. The oscillation frequency, the amplitude, and the mode of modulation of the high-frequency noise signal can all be controlled by the controller 40. In a case where the interfering wave is a pulse, a pulse generator (PG) can be used; in a case where the interfering wave is an impulse, an impulse generator (IG) can be used.

The RF (radio-frequency) amplifier 22 amplifies at a predetermined gain the high-frequency noise signal generated by the signal generator 21.

The bidirectional coupler (BDC) 23 splits the high-frequency noise signal amplified by the RF amplifier 22 into a traveling wave component traveling toward the DUT 10 and a reflected wave component returning from the DUT 10.

The traveling wave-side power sensor 24 measures the electric power of the traveling wave component split by the bidirectional coupler 23. On the other hand, the reflected wave-side power sensor 25 measures the electric power of the reflected wave component split by the bidirectional coupler 23. It is preferable that the transmission lines to the traveling wave-side and reflected wave-side power sensors 24 and 25 be both kept in a quasi cut-off state (e.g., with a power transmission of −20 dB or less).

The power meter 26 feeds the traveling-wave power measured by the traveling wave-side power sensor 24 and the reflected-wave power measured by the reflected wave-side power sensor 25 to the controller 40. The controller 40, by calculating the difference between the traveling-wave and reflected wave powers, calculates the electric power actually injected into the DUT 10, and records the result of the calculation. Thus, the electric power injected into the DUT 10 is measured by the power meter 26 located at a place far away from the DUT 10. Accordingly, for accurate measurement of the power injected into the DUT 10, it is desirable to accurately grasp the cable characteristics during transmission of a high-frequency noise signal.

The detector 30 monitors the output waveform of the DUT 10, and feeds the result of the monitoring to the controller 40. As the detector 30, an oscilloscope or the like can be suitably used. So that the presence of the detector 30 may not effect the electric component BCI test, it is preferable to use a differential probe with a high input impedance (1 MΩ) combined with a wide range (3 GHz) to keep the transmission line from the DUT 10 to the detector 30 in a quasi cut-off state.

The controller 40 is the agent that comprehensively controls the electric component BCI test. In conducting the electric component BCI test, the controller 40 controls the signal generator 21 such that it, while keeping the oscillation frequency of the high-frequency noise signal fixed, gradually increases the amplitude of the high-frequency noise signal (injected power). In parallel with the amplitude control just mentioned, the controller 40 also checks for malfunctioning of the LSI 11 (missing of a pulse in the clock signal, disturbance of its frequency, deviation of the output voltage from the rating, occurrence of a communication error or the like) according to the result of the monitoring by the detector 30. The controller 40 then acquires the result of calculation of the measured value from the power meter 26 on occurrence of malfunctioning of the LSI 11, and stores it in association with the oscillation frequency currently set. Thereafter, likewise, the controller 40 repeats the above measurement while sweeping the oscillation frequency of the high-frequency noise signal, and thereby determines a malfunctioning power-frequency response that associates the oscillation frequency of the high-frequency noise signal with the injected power on occurrence of malfunctioning. As the controller 40, for example, a personal computer that can sequentially perform the measurement described above can be suitably used.

The battery 50 is a direct-current power source that supplies electric power to the DUT 10. For example, in a case where a vehicle-mounted LSI is the evaluation target, as the battery 50, a vehicle-mounted battery can be used. However, usable as the direct-current power source for the DUT 10 is not only a battery but also, for example, an AC-DC converter that can generate desired direct-current electric power from commercial alternating-current electric power.

The power filter 60 is a circuit portion for keeping the transmission line from the noise source 20 to the battery 50 in a quasi cut-off state, and includes power impedance stabilization networks 61 and 62 (hereinafter referred to as the LISNs [line impedance stabilization networks] 61 and 62. The LISNs 61 and 62 both serve to stabilize the apparent impedance of the battery 50. The LISN 61 is inserted in a power line connecting between the positive terminal (+) of the battery 50 and a power terminal (VCC) of the DUT 10, and the LISN 62 is inserted in a GND line connecting between the negative terminal (−) of the battery 50 and a GND terminal (VEE) of the DUT 10.

The wire harness 70 is an electrically conductive member with a length of about 1.5 to 2.0 m that connects between the DUT 10 and the power filter 60. The wire harness 70 may be a single wire or a bundle of a plurality wires. The wire harness 70 is, at a predetermined position on it, fitted with the injection probe (injection transformer) 80, and a bulk current is injected into the wire harness 70 via the 50Ω transmission line 28 in the noise source 20.

In the electric component BCI test, it is prescribed that the total length of the wire harness 70 be 1700 mm to 2000 mm. The position at which the injection probe 80 is fitted (i.e., the distance from the DUT 10 to the injection probe 80) is also restricted to three places, namely 150 mm, 450 mm, and 750 mm.

<Vehicle BCI Test (ISO11451-4)>

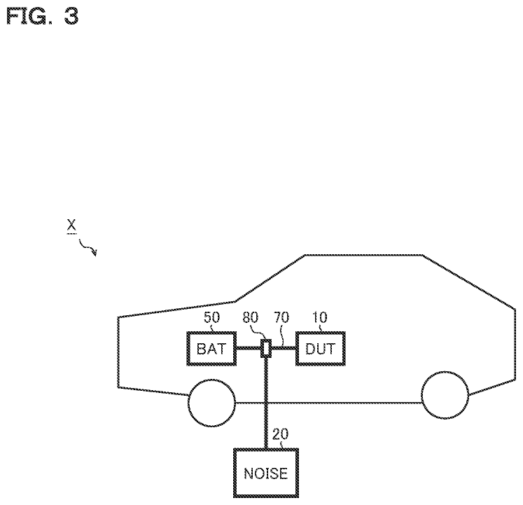

FIG. 3 is a block diagram showing one example of a vehicle BCI test. A vehicle BCI test is a BCI test that is conducted on the DUT 10, the wire harness 70, and the like described above in a state mounted on a vehicle X, and complies with ISO11451-4.

<Electric Component Emission Test (CISPR25)>

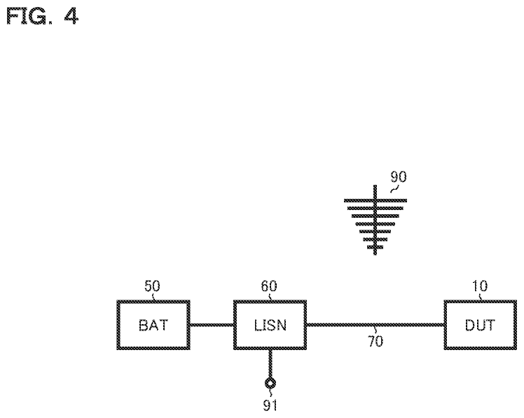

FIG. 4 is a block diagram showing one example of an electrical component emission test. An electrical component emission test is a measured benchmark for evaluation of the emission characteristics of an electric component, and complies with the standard CISPR 25 “Limits and methods of measurement for the protection of on-board receivers” formulated by International Special Committee on Radio Interference (CISPR). Electrical component emission tests divide into radiated emission tests and conducted emission tests. In a radiated emission test, the strength of noise radiated from the wire harness 70 is measured with an antenna 90. By contrast, in a conducted emission test, using a terminal 91 (not used in immunity tests) of the power filter 60, the strength of noise that conducts across the wire harness 70 is measured. Thus, the electrical component emission test differs, in configuration and purpose, from the electrical component BCI test (FIG. 2) and the vehicle BCI test (FIG. 3) mentioned previously. However, also in the electrical component emission test, the total length of the wire harness 70 is subject to a restriction, and in this respect it is no different from the electrical component BCI test (FIG. 2).

<Simulation Model>

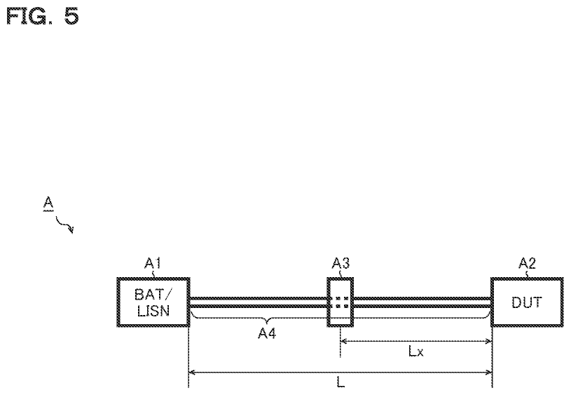

FIG. 5 is a block diagram showing one example of a simulation model. The simulation model A of this configuration example results from modeling an entire measured benchmark (the electrical component BCI test in FIG. 2), and is configured as a combination of a battery/LISN model A1, a DUT model A2, a BCI injection probe model A3, and a wire harness model A4.

The battery/LISN model A1 results from modeling the battery 50 and the power filter 60. In a case where not only the battery 50 and the power filter 60 but also a control system is connected, a control system model can be added in parallel with the battery/LISN model A1.

The DUT model A2 results from modeling the DUT 10. The DUT model A2 includes an LSI model resulting from modeling the LSI 11, a PCB model resulting from modeling the PCB, an immunity behavior model representing their immunity behavior, and the like.

The BCI injection probe model A3 results from modeling the injection probe 80.

The wire harness model A4 results from modeling the wire harness 70. The wire harness model A4 includes, as parameters representing its transmission characteristics, a parameter L commensurate with the total length of the wire harness 70, and a parameter Lx commensurate with the distance between the DUT 10 and the injection probe 80 (i.e., which distance can be understood as the noise injection position) (details will be given later).

In a case where a wire harness structure in an electrical component BCI test is modeled as it is, the values of the above-mentioned parameters L and Lx are restricted to reflect the restriction (1700 to 2000 mm) on the total length of the wire harness 70 and the restriction (150 mm, 450 mm, and 750 mm from the DUT 10) on the position of the injection probe 80.

<Method of Evaluation of Immunity Characteristics>

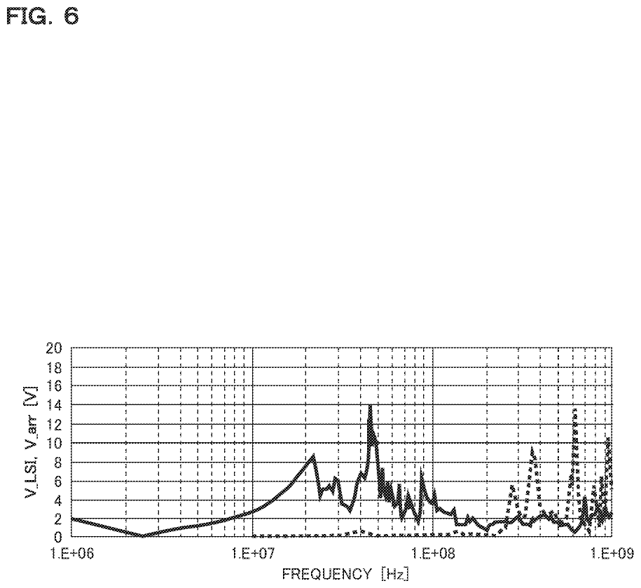

FIG. 6 is a diagram showing an example of a comparison of a malfunctioning voltage-frequency response (solid line) with an arriving voltage-frequency response (solid line).

The malfunctioning voltage-frequency response represents the strength of the high-frequency noise signal at the limit over which the LSI 11 malfunctions, as expressed in terms of the terminal voltage V_LSI appearing between predetermined points in the LSI 11. The malfunctioning voltage-frequency response can be determined from the malfunctioning power-frequency response (i.e., the strength of the high-frequency noise signal at the limit over which the DUT 10 malfunctions, as expressed in terms of the electric power injected into the DUT 10) acquired in a DPI (direct power injection) test. On the other hand, the arriving voltage-frequency response is the frequency response of an arriving voltage V_arr that arrives and appear between the predetermined points in the LSI 11 in an electric component BCI test (or in a computer simulation that simulates it).

Through a comparison of the malfunctioning voltage-frequency response with the arriving voltage-frequency response mentioned above, the immunity characteristics of the LSI 11 can be evaluated. For example, in FIG. 6, it can be inferred that, at oscillation frequencies at which the broken line passes above the solid line, the LSI 11 can malfunction. Through a similar comparison for each terminal of the LSI 11, it is possible to identify a terminal prone to malfunction, and thereby to improve the circuit design promptly.

For example, in a case where the broken line is found to pass above the solid line as in FIG. 6, it is possible to bring down the arriving voltage-frequency response (broken line), for example, by introducing a cable insusceptible to electromagnetic waves (e.g., a shielded twist cable or optical cable), or by providing a noise filter in the stage preceding the DUT 10. Through repetition of immunity characteristics evaluation of circuit re-designing, it is possible to build an optimal system.

For example, suppose that a system has been designed such that, with respect to a malfunctioning voltage-frequency response (solid line) and an arriving voltage-frequency response (broken line) as shown in FIG. 6, the solid line passes above the broken line, and thus so as to be free from malfunctioning. Then, if removing from the system one of the noise filters included in it results in part of the broken line passing above the solid line, this can be understood to indicate that the noise filter in question has been disposed appropriately in the system. Likewise, if replacing an electromagnetic wave-proof cable with an ordinary cable results in part of the broken line passing above the solid line, this can be understood to indicate that the electromagnetic wave-proof cable in question has been disposed appropriately in the system.

While with respect to FIG. 6 a method of evaluation of immunity characteristics has been described by way of an example of a comparison of a malfunctioning voltage-frequency response with an arriving voltage-frequency response, it is also possible to evaluate the immunity characteristics of the LSI 11 through a comparison of a malfunctioning current-frequency response (i.e., the strength of the high-frequency noise signal at the limit over which the LSI 11 malfunctions, as expressed in terms of the terminal current I_LSI flowing at a predetermined point in the LSI 11) with an arriving current-frequency response (i.e., the frequency response of an arriving current I_arr that arrives and flows at the predetermined point in the LSI 11 in an electrical component BCI test).

<Wire Harness Model>

Next, with respect to a simulation model of a wire harness used in an electrical component BCI test (FIG. 2) or in an electrical component emission test (FIG. 4), a revision of such a simulation model will be presented. The revision relates in particular to the modeling of a common-mode impedance in a wire harness. Specifically, through the following description, a method of laying wires when forming a wire harness by bundling together a plurality of wires will be formulated and a transmission line model that permits fast operation to cope with an actual wire harness structure will be presented.

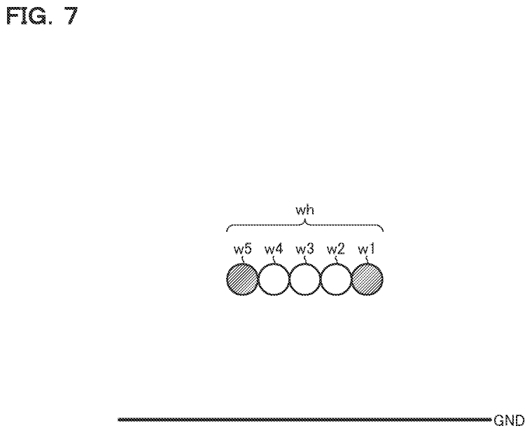

FIG. 7 is a sectional view schematically showing an example of wire arrangement in a wire harness. In the illustrated example, the wire harness wh is configured as a bundle of five wires w1 to w5. The wires w1 to w5 have the feature of being laid horizontally such that their respective coats lie in contact with each other. All the wires w1 to w5 are laid at a predetermined distance (e.g., 50 mm) from a ground plane (e.g., a copper plate on a table). An arrangement like this is in the present description referred to as “parallel arrangement”. It is assumed that, as the number of wires laid increases, they continue to be laid so as to be contiguous with each the other in the horizontal direction.

In the example illustrated in FIG. 7, the wires w1 and w5, indicated by hatching, are end lines and the wires w2 to w4, indicated as hollow circles, are middle lines. An end line denotes, of a plurality of wires in a parallel arrangement, one having no other wire contiguous with it at least on one side. On the other hand, a middle line denotes a wire having other wires contiguous with it on both sides. Any number of wires may be laid in a parallel arrangement.

The transmission characteristics of a wire harness depend on the presence of a GND (such as a ground plane) that lies opposite it. In terms of their positional relationship, the wire harness and the GND can be located, when closest together, contiguous with each other and, when farthest from each other, at infinity from each other. To follow will be a detailed discussion of differences in transmission characteristics between an end line and a middle line (i.e., arrangement position-dependence of transmission characteristics.

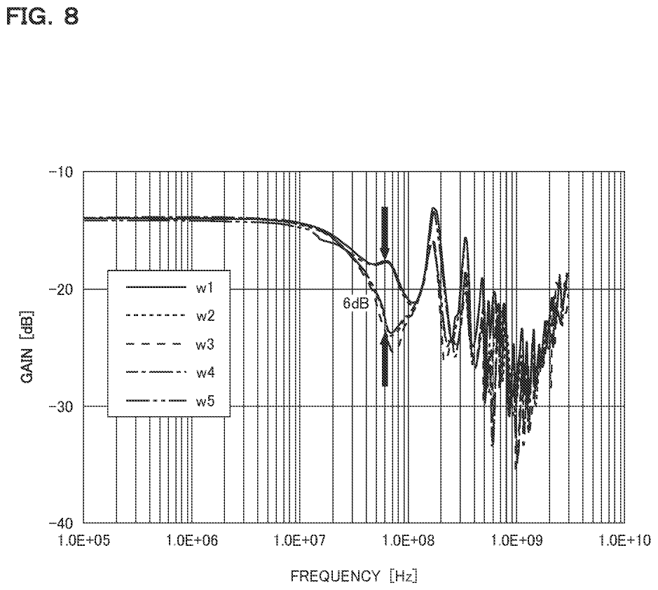

FIG. 8 is a frequency-gain diagram illustrating the arrangement position-dependence of the transmission characteristics of each of the wires w1 to w5. The measurement results shown there come from an actual test environment where, for five wires w1 to w5 laid in a parallel arrangement, their respective first ends are short-circuited together and their respective second ends are given a terminal structure of 250Ω except that, for only the test target wire, the terminal resistor is replaced with a series resistor of 200Ω. Needless to say, used as the wires w1 to w5 are ones with substantially equal impedances on a DC basis.

For example, a comparison of the transmission characteristics of the wire w1 (solid line) and the transmission characteristics of the wire w2 (short-segment broken line) reveals differences in transmission characteristics in the frequency band of 40 MHz to 100 MHz, with a marked difference of 6 dB (approximately four times) observed at 61 MHz (see the points indicated by thick arrows in the diagram). These differences suggest that, in a situation where the wire harness wh is exposed to interference noise, the interfering energy does not evenly propagate to the wires w1 and w2.

On the other hand, no marked differences are observed in the above-mentioned frequency band between the transmission characteristics of the wire w1 (solid line) and the transmission characteristics of the wire w5 (dash-dot-dot line). Likewise, no marked differences are observed in the above-mentioned frequency band between the transmission characteristics of the wire w2 (short-segment broken line), the transmission characteristics of the wire w3 (long-segment broken line), and the transmission characteristics of the wire w5 (dash-and-dot line).

Based on the measurement results above, the present inventor noted that the characteristic impedance of each of the wires w1 to w5 laid in a parallel arrangement exhibited a tendency according to its arrangement (surroundings), and this has led to a finding that the wires w1 to w5 can be classified into at least two classes, namely into an end line group (w1 and w5) and a middle line group (w2 to w4).

In conventional wire harness models, for simplicity's sake, the interaction between contiguous wires is ignored, and all wires are expressed uniformly as if each had a single characteristic impedance. Accordingly, in conventional wire harness models, equal currents and voltages appear in all of the wires w1 to w5 under identical terminal conditions, and it is thus impossible to express differences according to their arrangement. Moreover, with lumped parameters, no reflection is considered, and thus it is impossible to express a standing wave that depends on the total length of the wire harness.

By contrast, classifying a wire harness wh into at least two classes, namely into an end line group (w1 and w5) and a middle line group (w2 to w4) makes it possible to reproduce transmission characteristics that cannot be expressed with a conventional wire harness model with a single characteristic impedance, or with lumped parameters.

<Model Classification>

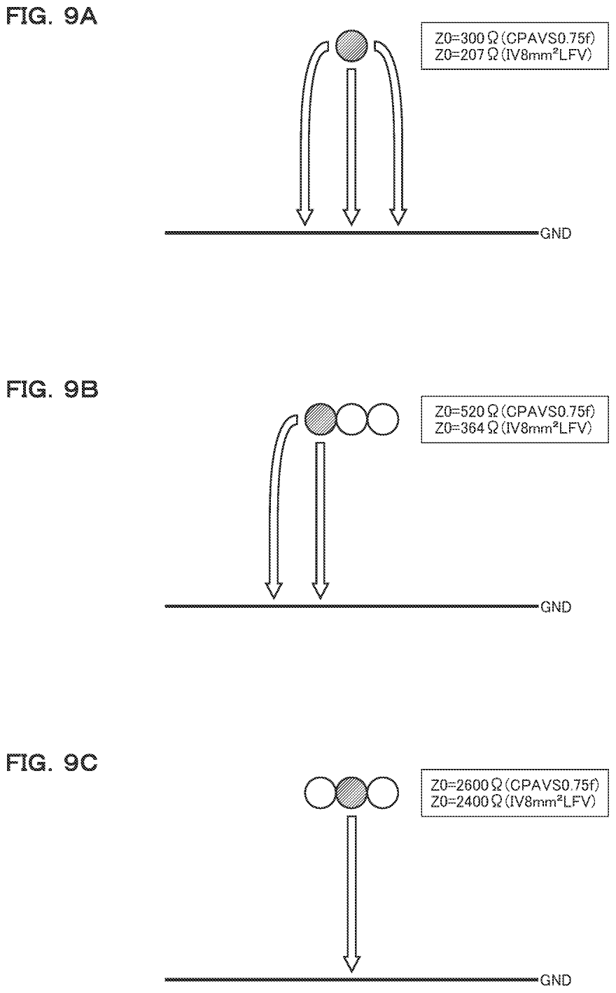

FIGS. 9A to 9C are each a sectional view schematically showing a wire harness. In these diagrams, a wire indicated with hatching is modeled as a single-line model (FIG. 9A), an end-line model (FIG. 9B), and a middle-line model (FIG. 9C) respectively. The bottom of each diagram corresponds to a ground plane.

The single-line model (FIG. 9A) models a wire with no other wire contiguous with it on either side (i.e., a single line). Thus the single-line model (FIG. 9A) does not correspond to a case where a plurality of wires are laid in a parallel arrangement; even so it will be described, as a basic unit of a transmission line model, along with the end-line model (FIG. 9B) and the middle-line model (FIG. 9C). The single-line model (FIG. 9A) can be understood as a special example of the end-line model (FIG. 9B).

In the diagrams, hollow arrows represent representative lines of electric force. As will be understood from a comparison of the diagrams with each other, different arrangements of wires produce differently distributed electric fields, resulting in three different characteristic impedances (for a single-line model, an end-line model, and a middle-line model). In each diagram, two types of wires (CPAVS0.75f and IV8mm²LFV) are taken as examples so that, for each model, two characteristic impedances Z0 are shown.

In the single-line model (FIG. 9A), with CPAVS0.75f, Z0=300Ω and, with 8 mm²LFV, Z0=207Ω. In the end-line model (FIG. 9B), with CPAVS0.75f, Z0=520Ω and, with IV8 mm²LFV, Z0=364Ω. In the middle-line model (FIG. 9C), with CPAVS0.75f, Z0=2600Ω and, with IV8mm²LFV, Z0=2400Ω.

It is thus understood that there is a difference of about one digit between, at one end, the single-line model (FIG. 9A) and the end-line model (FIG. 9B) and, at the other end, the middle-line model (FIG. 9C).

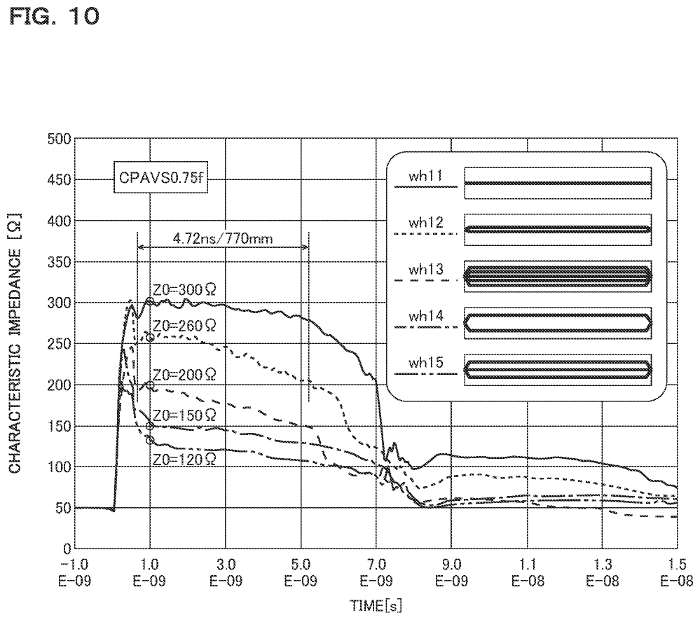

FIG. 10 is a measured waveform diagram obtained while deriving the characteristic impedance of CPAVS0.75f. The wire harnesses wh11 to wh15 used in the characteristic impedance measurement had, as indicated in the legends, the following wire arrangements: wh11 (solid line), a single line; wh12 (short-segment broken line), two lines in a parallel arrangement; wh13 (long-segment broken line), five lines in a parallel arrangement; wh14 (dash-and-dot line), two lines in a parallel arrangement (with a wire-to-wire distance of 100 mm); and wh15 (dash-dot-dot line), three lines in a parallel arrangement (with a wire-to-wire distance of 50 mm).

The characteristic impedance was measured by TDR (time-domain reflectometry), using an analyzer, model Agilent 8510C (incorporating IFFT [inverse fast Fourier transform]), in a measurement band of 45 MHz to 18.045 GHz, at 401 measurement points, and in a measurement range of 1 ns to 15 ns. In the characteristic impedance measurement, the wires were each short-circuited across opposite ends, and the characteristic impedance was acquired as the common-mode impedance of the straight portion of the wire harness.

The wire harness wh11 (solid line) gave the measurement result Z0=300Ω. The wire harness wh11 can be understood as a single wire on its own. Accordingly, the characteristic impedance of the single-line model can be set to 300Ω (see FIG. 9A).

The wire harness wh12 (short-segment broken line) gave the measurement result Z0=260Ω. The wire harness wh12 can be understood as two end lines laid in a parallel arrangement. Accordingly, the characteristic impedance of the end-line model can be set to 520Ω (=260Ω×2) (see FIG. 9B).

The wire harness wh13 (long-segment broken line) gave the measurement result Z0=200Ω. The wire harness wh13 can be understood as two end lines and three middle lines laid in a parallel arrangement. Accordingly, let the impedance of the middle-line model be R, then Expression (1) below holds.

1/200=2/520+3/R (1)

Solving Expression (1) permits the characteristic impedance of the middle-line model to be determined as 2600Ω (see FIG. 9C).

The wire harness wh14 (dash-and-dot line) gave the measurement result Z0=150Ω, and the wire harness wh15 (dash-dot-dot line) gave the measurement result Z0=120Ω. A comparison of these measurement results with the measurement result (Z0=300Ω) of the wire harness wh11 (solid line) confirms that a wire-to-wire distance of 100 mm or more permits each parallel-arranged wire to exhibit transmission characteristics equivalent to those of a single line.

In the measurement results with all of the wire harnesses wh11 to wh15, a delay time of 4.72 ns/770 mm was observed. This permits a unit delay time per a unit length (1 m) to be determined as 6.13 ns/m.

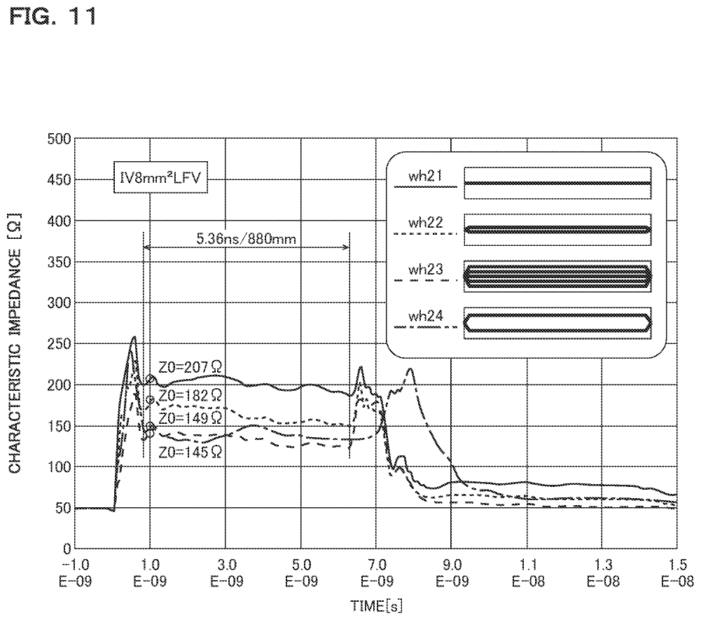

FIG. 11 is a measured waveform diagram obtained while deriving the characteristic impedance of IV8mm²LFV. The wire harnesses wh21 to wh24 used in the characteristic impedance measurement had, as indicated in the legends, the following arrangements: wh21 (solid line), a single line; wh22 (short-segment broken line), two lines in a parallel arrangement; wh23 (long-segment broken line), five lines in a parallel arrangement; and wh24 (dash-and-dot line), two lines in a parallel arrangement (with a wire-to-wire distance of 100 mm).

The wire harness wh12 (solid line) gave the measurement result Z0=207Ω. The wire harness wh21 can be understood as a single wire on its own. Accordingly, the characteristic impedance of the single-line model can be set to 207Ω (see FIG. 9A).

The wire harness wh22 (short-segment broken line) gave the measurement result Z0=182Ω. The wire harness wh22 can be understood as two end lines laid in a parallel arrangement. Accordingly, the characteristic impedance of the end-line model can be set to 364Ω (=182Ω×2) (see FIG. 9B).

The wire harness wh23 (long-segment broken line) gave the measurement result Z0=149Ω. The wire harness wh23 can be understood as two end lines and three middle lines laid in a parallel arrangement. Accordingly, let the impedance of the middle-line model be R, then Expression (2) below holds.

1/149=2/364+3/R (1)

Solving Expression (2) permits the characteristic impedance of the middle-line model to be determined as 2400Ω (see FIG. 9C).

The wire harness wh24 (dash-and-dot line) gave the measurement result Z0=145Ω. A comparison of this measurement result with the measurement result (Z0=207Ω) of the wire harness wh21 (solid line) confirms that, even with a wire-to-wire distance of 100 mm or more, interference occurs among parallel-arranged wires.

In the measurement results with all of the wire harnesses wh21 to wh24, a delay time of 5.36 ns/880 mm was observed. This permits a unit delay time per a unit length (1 m) to be determined as 6.09 ns/m.

<Transmission Line Model>

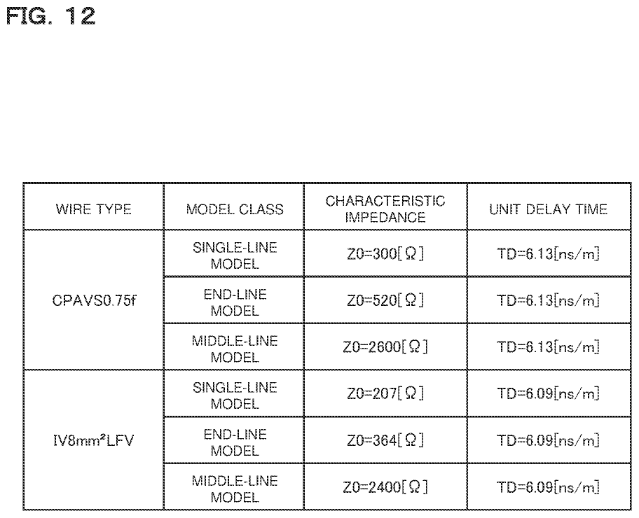

On the basis of the measurement results above, transmission line models (e.g., SPICE models) for wires will be presented. FIG. 12 is a table showing the values of parameters in transmission line models, giving characteristic impedances and unit delay times across different wire types (CPAVS0.75f/IV8mm²LFV) and different model classes (single-line model, end-line model, middle-line model).

While, for different wire types (types of transmission lines), CPAVS0.75f is taken as a low-voltage transmission line (signal line) and IV8mm²LFV is taken as a high-voltage transmission line (power line), any different types of wires can be modeled as necessary.

In the single-line model of CPAVS0.75f, the characteristic impedance is set to Z0=300 [Ω] and the unit delay time is set to TD=6.13 [ns/m]. In the end-line model of CPAVS0.75f, the characteristic impedance is set to Z0=520 [Ω] and the unit delay time is set to TD=6.13 [ns/m]. In the middle-line model of CPAVS0.75f, the characteristic impedance is set to Z0=2600 [Ω] and the unit delay time is set to TD=6.13 [ns/m].

On the other hand, in the single-line model of IV8mm²LFV, the characteristic impedance is set to Z0=207 [Ω] and the unit delay time is set to TD=6.09 [ns/m]. In the end-line model of IV8mm²LFV, the characteristic impedance is set to Z0=364 [Ω] and the unit delay time is set to TD=6.09 [ns/m]. In the middle-line model of IV8mm²LFV, the characteristic impedance is set to Z0=2400 [Ω] and the unit delay time is set to TD=6.09 [ns/m].

In this way, the characteristic impedances of different models are set to different values according to the model class of wires (single-line model, end-line model, middle-line model). In particular, with attention paid to the end-line and middle-line models, the characteristic impedance of an end-line model is set to a value lower by about one digit than the characteristic impedance of the middle-line model. On the other hand, the unit delay times of those models are set to equal values without regard to the model class of wires. The characteristic impedance and the unit delay time are set separately for each different wire type.

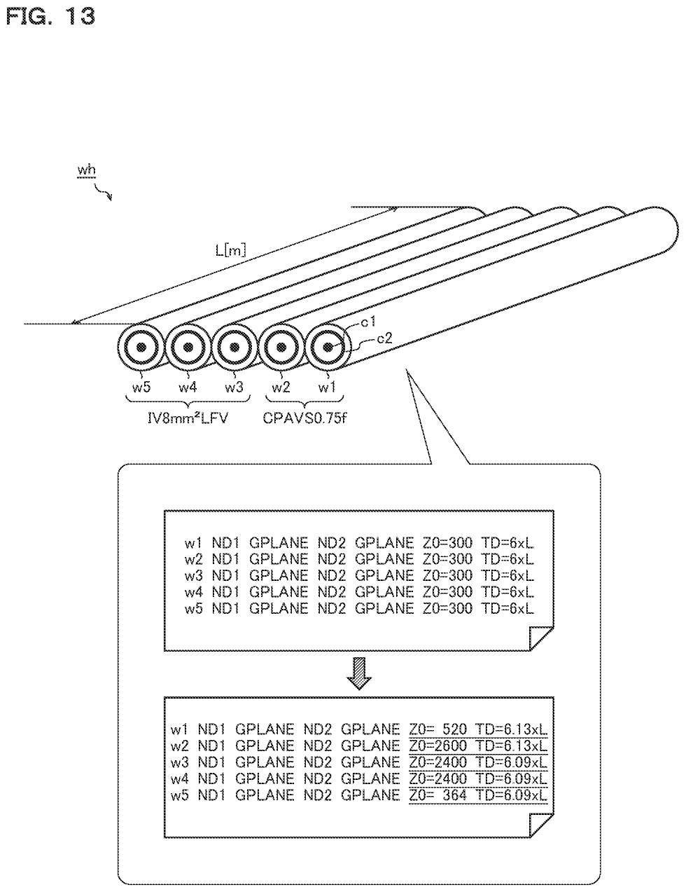

FIG. 13 is a schematic diagram showing examples of the description of a transmission line model. In the illustrated example, a wire harness wh results from laying five wires w1 to w5 in a parallel arrangement, and has a total length of L (m). For wire types, it is assumed that the wires w1 and w2 are CPAVS0.75f and the wires w3 to w5 are IV8mm²LFV.

On the other hand, with attention paid to the arrangement of the wires w1 to w5, the wires w1 and w5 are classified as end lines and the wires w2 to w4 are classified as middle lines. Accordingly, the wire harness wh can be expressed appropriately by a combination of the end-line and middle-line models.

It is assumed that a transmission line model is described by a sequence of parameters in the following order: wire number (name), first-port connection destination of inner conductor c1, first-port connection destination of outer conductor c2, second-port connection destination of inner conductor c1, second-port connection destination of outer conductor c2, characteristic impedance Z0, and delay time TD (=Unit Delay Time×Total Length)

For example, the description at the first line in the upper frame in the balloon, “w1 ND1 GPLANE ND2 GPLANE Z0=300 TD=6×L”, can be interpreted to convey: “as for the wire w1, the connection destination of the first port of the inner conductor c1 is a node ND1, the connection destination of the first port of the outer conductor c2 is the ground plane, the connection destination of the second port of the inner conductor c1 is a node ND2, the connection destination of the second port of the outer conductor c2 is the ground plane, the characteristic impedance Z0 is 300 [Ω], the delay time TD is 6×L [ns].

It should be noted that the upper frame in the balloon shows the description of a conventional transmission line model in which the wires w1 to w5 are expressed with a single characteristic impedance (Z0=300 [Ω]); in contrast, the lower frame in the balloon shows the description of a novel transmission line models in which the wires w1 to w5 are expressed with characteristic impedances that differ according to their respective arrangement.

Specifically, the wire w1 is modeled as an end-line model of CPAVS0.75f (Z0=520 [Ω], TD=6.13×L [ns]); the wire w2 is modeled as a middle-line model of CPAVS0.75f (Z0=2600 [Ω], TD=6.13×L [ns]); the wires w3 and w4 are both modeled as a middle-line model of IV8mm2LFV (Z0=2400 [Ω], TD=6.09×L [ns]); the wire w5 is modeled as an end-line model of IV8mm2LFV (Z0=364 [Ω], TD=6.09×L [ns]).

Thus, the novel transmission line model presented herein is created through a step of classifying the wires to be modeled into two classes, namely end line and middle line (or into three classes further including single line), according to their respective arrangement and a step of individually modeling the two classes, namely an end line and a middle line (or three classes further including a single line) into two classes, namely an end-line model and a middle-line model (or into three classes further including a single line model).

With this transmission line model, as opposed to the conventional transmission line model, it is possible to faithfully reproduce differences (see FIG. 8) in transmission characteristics according to the arrangement of wires, and thus to reduce deviations between measured and simulated values.

Nonetheless, the transmission line model presented herein, including as parameters representing its transmission characteristics the characteristic impedance Z0 and the delay time TD, is in this respect no different from the conventional transmission line model (compare the upper and lower frames in the balloon in FIG. 13). Thus, the time required for preparing and conducting an EMC computer simulation is not much affected.

A transmission line model can be expressed either with loss taken into account (loss-inclusive) or with loss ignored (loss-free). In the former case, loss can be expressed in a number of ways. Incidentally, the total length of a wire harness used in an electrical component BCI test (FIG. 2) or an electrical component emission test (FIG. 4) as mentioned earlier is about 2 m and, even with consideration given to its being mounted on a vehicle, the total length is about 10 m. Seeing that, it is preferable to use whichever of a loss-inclusive transmission line model and a loss-free transmission line model is appropriate as necessary. It should be noted that the characteristic impedances and the unit delay times specifically mentioned above are all examples of values in loss-free models.

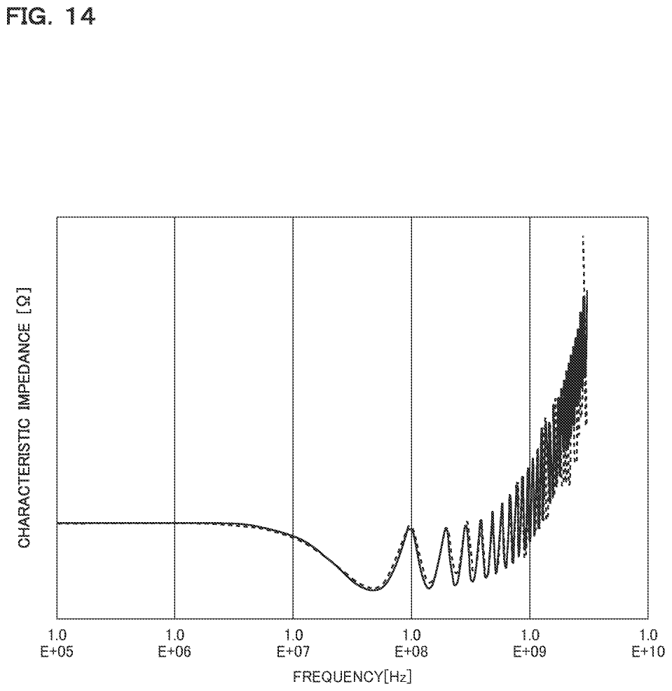

FIG. 14 is a frequency-characteristic impedance diagram showing an example of verification of reproduction by transmission line simulation. In the diagram, the solid line represents the simulated value (with loss taken into account) and the broken line represents the measured value. The diagram reveals a good agreement of the actual behavior with the behavior indicated by the broken line. For example, with a transmission line model that takes into account electric power dissipated as heat and electric power lost in radiation, it is possible to calculate the amount of radiation.

<Application in Vehicle Body Test>

In the electrical component BCI test (FIG. 2) mentioned earlier, to ensure its practicability, one out of a variety of wire harness structures (there are as many as there are kinds of vehicles) is fixed and the noise injection point is limited to three discrete points.

However, the wire harnesses that are laid in real vehicles have varying total lengths from 100 mm to 5000 mm and have greatly varying numbers of wires from one to about 60. Thus, there is no denying that very many phenomena cannot be predicted and are overlooked in electrical component BCI tests.

By contrast, presented herein is a method of computer simulation in which the parameters (e.g., characteristic impedance, delay time, and number of wires laid) of a transmission line model that models a wire harness are given variable values and, while these parameters are swept within predetermined ranges, the immunity characteristics or emission characteristics of a DUT are evaluated.

First, with reference to some specific examples of changes in parameters, a description will be given of how those changes cause changes in the description of a transmission line model.

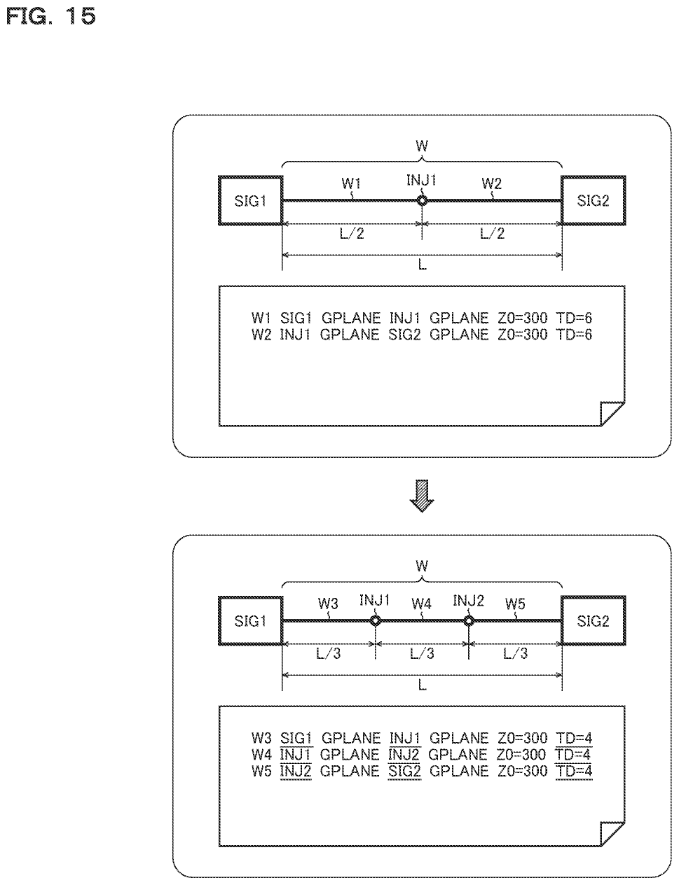

FIG. 15 is a diagram showing, for a case where the number of noise injection points is to be increased from one to two, how to change the description of a transmission line model.

As shown in the upper pane of FIG. 15, in a case where a wire W (total length: L) laid between signal nodes SIG1 and SIG2 has a noise injection point INJ1 fitted to it at one place (in the illustrated example, at a point at which the wire W is divided in two equal parts), understanding the part laid between the signal node SIG1 and the noise injection point INJ1 as a division wire W1 (length: L/2) and the part laid between the noise injection point INJ1 and the signal node SIG2 as a division wire W2 (length: L/2) gives a description of the transmission line model as follows:

W1 SIG1 GPLANE INJ1 GPLANE Z0=300 TD=6

W2 INJ1 GPLANE SIG2 GPLANE Z0=300 TD=6

By contrast, as shown in the lower pane of FIG. 15, in a case where the wire W has noise injection points INJ1 and INJ2 fitted to it at two places (in the illustrated example, at points at which the wire W is divided into three equal parts), understanding the part laid between the signal node SIG1 and the noise injection point INJ1 as a division wire W3 (length: L/3), the part laid between the noise injection points INJ1 and INJ2 as a division wire W4 (length: L/3), and the part laid between the noise injection point INJ2 and the signal node SIG2 as a division wire W5 (length: L/3) gives a description of the transmission line model as follows:

W3 SIG1 GPLANE INJ1 GPLANE Z0=300 TD=4

W4 INJ1 GPLANE INJ2 GPLANE Z0=300 TD=4

W5 INJ2 GPLANE SIG2 GPLANE Z0=300 TD=4

As described above, when a noise injection point is added, a wire becomes divided into an increased number of parts, and this can be coped with by increasing the number of lines in the description of the transmission line model accordingly. Moreover, when a noise injection point is added, the length of the division wires changes, and this can be coped with by appropriately rewriting delay times TD in the transmission line model.

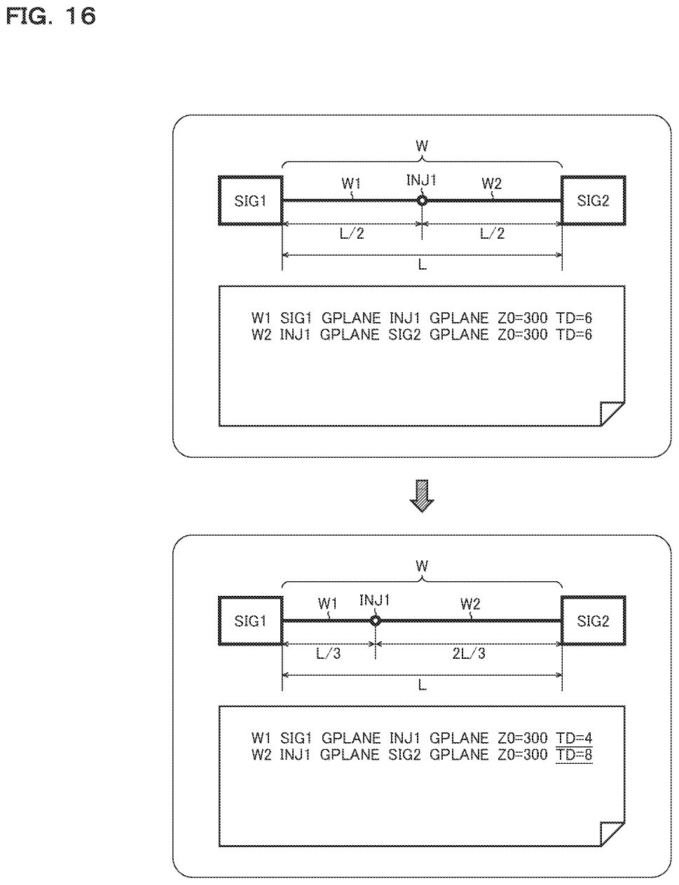

FIG. 16 is a schematic diagram showing, for a case where a noise injection position is changed, how to change the description of a transmission line model.

In the upper pane of FIG. 16, as in the upper pane of FIG. 15, a wire W (total length: L) laid between signal nodes SIG1 and SIG2 has a noise injection point INJ1 fitted to it at a point at which the wire W is divided into two equal parts. Accordingly, the transmission line model can be described as follows:

W1 SIG1 GPLANE INJ1 GPLANE Z0=300 TD=6

W2 INJ1 GPLANE SIG2 GPLANE Z0=300 TD=6

By contrast, in the lower pane of FIG. 16, the noise injection point INJ1 is fitted not to the point at which the wire W is divided into two equal parts but to one of the points at which the wire W is divided into three equal parts (in the illustrated example, at the point that gives the division wire W1 a length of L/3 and the division wire W2 a length of 2 L/3. Accordingly, the transmission line model can be described as follows:

W1 SIG1 GPLANE INJ1 GPLANE Z0=300 TD=4

W2 INJ1 GPLANE SIG2 GPLANE Z0=300 TD=8

In a case where a noise injection position is changed as described above, the lengths of division wires change, and this can be coped with by appropriately rewriting delay times TD in the transmission line model. Needless to say, though not specifically illustrated, also when the total length of a wire is to be changed, this can be coped with by rewriting delay times TD.

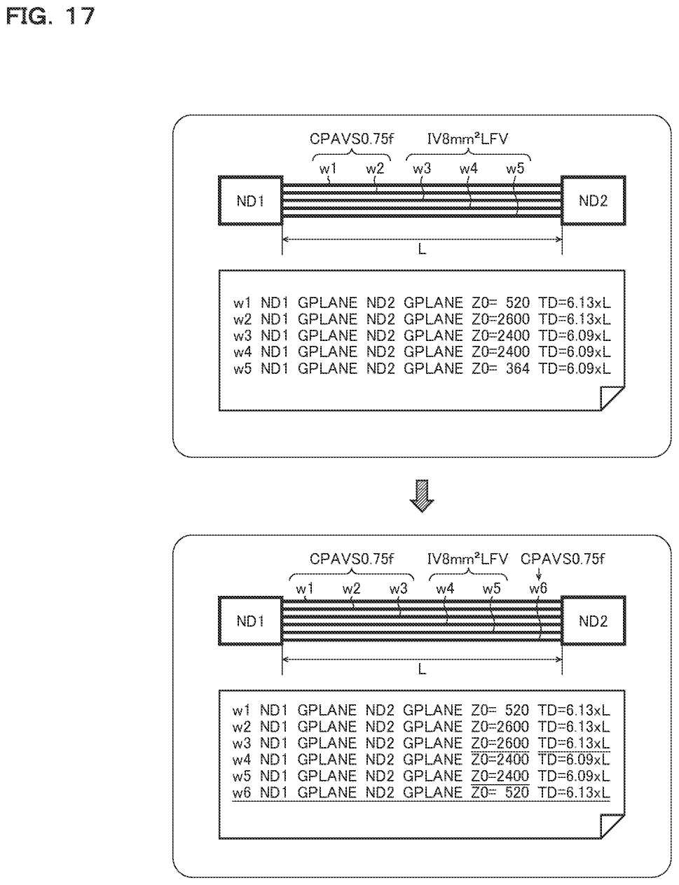

FIG. 17 is a schematic diagram showing, for a case where the wire arrangement is to be changed, how to change the description of a transmission line model.

In the upper pane of FIG. 17, as in FIG. 13, five wires w1 to w5 (total length: L) are laid in a parallel arrangement between nodes ND1 and ND2. Here, the wire types are as follows: the wires w1 and w2, CPAVS0.75f; wires w3 to w5, IV8mm²LFV. The wires w1 and w5 are classified as end lines, and the wires w2 to w4 are classified as middle lines. Accordingly, the transmission line model can be described as follows:

w1 ND1 GPLANE ND2 GPLANE Z0=520 TD=6.13×L

w2 ND1 GPLANE ND2 GPLANE Z0=2600 TD=6.13×L

w3 ND1 GPLANE ND2 GPLANE Z0=2400 TD=6.09×L

w4 ND1 GPLANE ND2 GPLANE Z0=2400 TD=6.09×L

w5 ND1 GPLANE ND2 GPLANE Z0=364 TD=6.09×L

By contrast, in the lower pane of FIG. 17, the wire w3 has been changed from IV8mm²LFV to CPAVS0.75f. Moreover, the wire w5 has been changed from an end line to a middle line. Furthermore, as a new end line, a wire w6 (CPAVS0.75f) is added. In this case, the transmission line model can be changed as follows:

w1 ND1 GPLANE ND2 GPLANE Z0=520 TD=6.13×L

w2 ND1 GPLANE ND2 GPLANE Z0=2600 TD=6.13×L

w3 ND1 GPLANE ND2 GPLANE Z0=2600 TD=6.13×L

w4 ND1 GPLANE ND2 GPLANE Z0=2400 TD=6.09×L

w5 ND1 GPLANE ND2 GPLANE Z0=2400 TD=6.09×L

w6 ND1 GPLANE ND2 GPLANE Z0=520 TD=6.13×L

The changes made in the description above will be described. First, for the wire w3, as the wire type is changed (from IV8mm²LFV to CPAVS0.75f), the characteristic impedance Z0 of the wire w3 is changed from 2400 to 2600 and the delay time TD of the wire w3 is changed from 6.09×L to 6.13×L. For the wire w5, as the model class is changed (from end line to middle line), the characteristic impedance Z0 of the wire w5 is changed from 364 to 2400. Moreover, as the wire w6 is added, one description line for the wire w6 is added. The description of the wire w6 is the same as that of the wire w1.

In this way, by changing the parameters (e.g., characteristic impedance, delay time, and number of wires laid) of a transmission line model as necessary, it is possible to represent, in a simple manner, the measurement environment structures of a variety of electric components and, further, to reproduce wire harness structures to be laid in vehicles. It is thus possible to satisfactorily cover, in computer simulations, phenomena that can occur in reality, without being subject to restrictions associated with measured benchmarks.

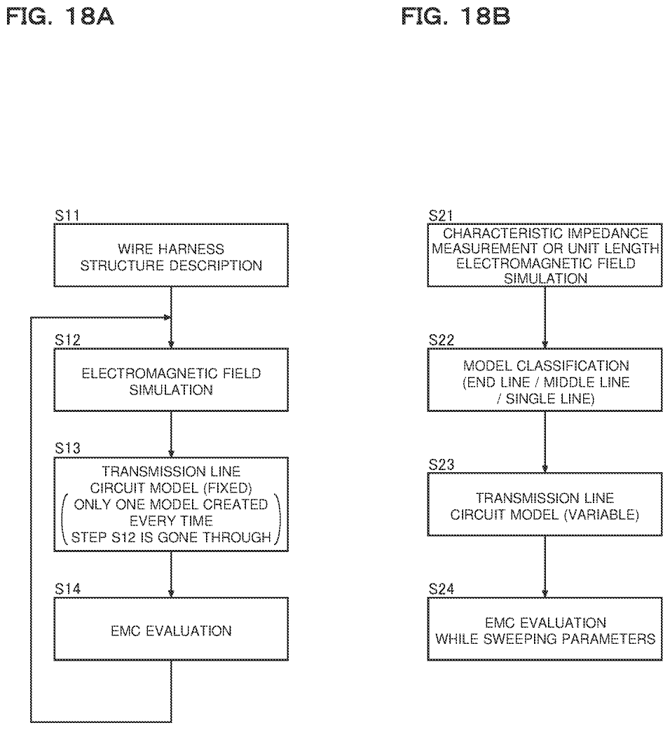

FIGS. 18A and 18B are flow charts showing, respectively, a conventional and a new method of EMC evaluation. FIG. 18A shows an operation flow of a common method of EMC evaluation. FIG. 18B shows an operation flow of a novel method of EMC evaluation presented herein.

As shown in FIG. 18A, in a common method of EMC evaluation, first, at step S11, a wire harness structure is described for each vehicle. The wire harness structure here is obtained by analyzing on a three-dimensional level the wire harness network actually laid around the vehicle and creating a detailed description of its structure based on the results of the analysis.

Next, at step S12, using the wire harness structure above, an electromagnetic field simulation is performed, and subsequently, at step S13, a transmission line circuit model that is fixed for each vehicle is created. Here, as a matter of course, there is a restriction: one session of the electromagnetic field simulation at step S12 can only create one transmission line circuit model.

Then, at step S14, by computer simulation using the transmission line circuit model above, EMC evaluation (i.e., evaluation of immunity characteristics or emission characteristics) is performed on an electrical component. Here, as mentioned above, the transmission line circuit model can be created only one in one session of the electromagnetic field simulation at step S12. Thus, in a situation where EMC evaluation on an electrical component has to be performed using a plurality of kinds of transmission line circuit models, it is necessary to repeat the electromagnetic field simulation at step S12 as many times as the number of kinds of transmission line circuit models (the number of fixed shapes) while changing conditions.

Inconveniently, performing one session of electromagnetic field simulation requires at least several tens of hours and, for increased simulation accuracy, even several hundred hours. Thus, an attempt to create many kinds of transmission line circuit models to encompass all condition changes as exemplarily shown in FIGS. 15 to 17 (adding a noise injection point, changing a noise injection position, changing the total length of a wire, and changing the wire arrangement) requires several hundred to several thousand hours. This makes the conventional method far from being practical.

As described above, the EMC evaluation flow in FIG. 18A presupposes specific vehicles in the first place and is therefore not very versatile. Accordingly, it is unsuitable for EMC evaluation on electric components mounted on any vehicles or for computer simulation giving consideration to changes that may arise in the wire harness structure while a vehicle is running.

By contrast, as shown in FIG. 18B, in the novel method of EMC evaluation presented herein, first, at step S21, the characteristic impedance of a wire harness is measured. This measurement of the characteristic impedance just has to be performed for each wire type (e.g., CPAVS0.75f and the IV8mm²LFV). What is specifically done at this step has been described above with reference to FIGS. 10 and 11, and thus no overlapping description will be repeated. The characteristic impedance of a wire harness may be acquired by unit-length electromagnetic field simulation.

Nest, at step S22, the plurality of wires that constitute the wire harness are classified into model classes (end line, middle line, and single line). Also this model classification, like the impedance measurement mentioned above, just has to be performed for each wire type. What is specifically done at this step has been described above with reference to FIGS. 9A to 9C and 12, and thus no overlapping description will be repeated.

Thereafter, at step S23, a plurality of segmentalized transmission line models and various elements (such as a DUT model, a LISN model, and a battery model) connected to them are combined as necessary to create a variable transmission line circuit model. That is, the variable transmission line circuit model created at this step includes parameters related to noise injection positions and wire arrangement (and hence wire harness structure itself), and by giving those parameters variable values, it is possible to reproduce a variety of test conditions.

Based on what has been done thus far, subsequently, at step S24, by computer simulation using the transmission line circuit model above, while various parameters (e.g., characteristic impedance, delay time, and number of wires laid) are swept, EMC evaluation on an electric component is performed. That is, at this step, it is possible to reproduce a variety of test conditions (wire harness structures) while changing various parameters, without repeating many times quite time-consuming electromagnetic simulation (see step S12). It is thus possible to screen out worst-case conditions very efficiently in a short time.

As described above, the conventional and novel methods for EMC evaluation greatly differ in whether the speed of the operation for changing test conditions is restricted by electromagnetic simulation. That is, with the novel method of EMC evaluation presented herein, it is possible, by parameterizing a variety of vehicle structures without oversimplifying them into one, to change test conditions continuously independently of electromagnetic simulation. It is thus possible to allow greater latitude in the setting of test conditions, and thus to evaluate the immunity characteristics or emission characteristics of electrical components more correctly than ever.

<Parameter Sweeping Range>

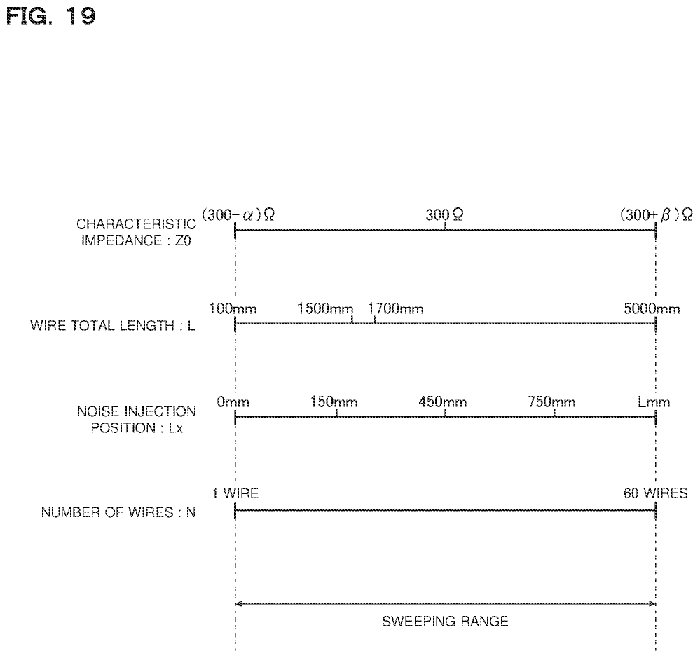

FIG. 19 is a schematic diagram showing the sweeping ranges of various parameters (characteristic impedance, wire total length, noise injection positions, and number of wires).

The characteristic impedance Z0 is swept so as to reproduce changes in the arrangement or type of a wire. Changes in the arrangement of a wire can include, in addition to a change in the model class (end-line model, middle line, and single-line model) as mentioned above, any changes of state that may affect the characteristic impedance of a wire, such as a deviation in the position of a wire (a change in the distance of a wire from the ground plane attributable to vibration during traveling, secular change, temperature change, humidity change, or the like), a change in the vehicle model (vehicle body structure), and a change in the body material.

The sweeping range for the characteristic impedance Z0 can be set to (300=α)Ω≤Z0≤(300+β) Ω so as to cover values (e.g., 300Ω) that are subject to restrictions equivalent to those for measured benchmarks. Also for the sweeping ranges for the wire total length L and the noise injection position Lx, they can be set so as to cover values that are subject to restrictions equivalent to those for measured benchmarks. For example, the sweeping range for the wire total length L can be set, so as to cover the range from 1500 mm to 1700 mm and with consideration given to the lengths of wires to be actually laid in a vehicle, to 100 mm≤L≤5000 mm. For another example, the sweeping range for the noise injection position Lx can be set, so as to cover 150 mm, 450 mm, and 750 mm, to 0 mm≤Lx≤L mm.

Setting the sweeping ranges for the characteristic impedance Z0, the wire total length L, and the noise injection position Lx as described above makes it possible to verify simulation results using conventional measured benchmarks (i.e., to check simulation results against measured results).

For the sweeping of the wire total length L and the noise injection position Lx, actually the delay time TD is swept so as to reproduce it.

The sweeping range for the number of wires N can be set, with consideration given to actual wire harnesses, to 1≤N≤60.

While the above description deals with an example where the sweeping ranges for various parameters are set on the basis of measured benchmarks, they may be set by any other method. For example, the sweeping ranges for various parameters may be set so as to cover the values calculated by describing the structure of a transmission line circuit in a real device (step S11 in FIG. 18).

Through such setting, it is possible to perform computer simulation that faithfully reflects various conditions that may occur on a real vehicle. It is thus possible to evaluate, without overlooking, phenomena (e.g., unintended variations in immunity characteristics or emission characteristics due to a deviation in the position of a wire attributable to vibration during traveling) that are overlooked with a conventional method for EMC evaluation (FIG. 18A) however long a time may be expended.

<Simultaneous Multiple Injection Model>

As mentioned in the Background Art section, when a real vehicle is exposed to EMC interference from outside (e.g., when a vehicle is exposed to a thunderbolt), the entire wire harness network (see FIG. 1) laid around the vehicle is interfered simultaneously. In that event, different wire harnesses may experience different intensities of interference, or a group of wire harnesses connected in series may experience interference. Thus, to reproduce actual EMC interference, it is necessary to apply interference to a plurality of wire harnesses that are affected simultaneously.

Inconveniently, setting a plurality of noise injection points in a conventional EMC test requires procuring as many pieces of EMC test equipment (such as class-A amplifiers of the order of several kilowatts), each costing several tens of millions of Japanese yen, as the number of noise injection points. This is impractical from the perspective of costs.

Thus, in a conventional measured benchmark (e.g., the electrical component BCI test in FIG. 2 or the vehicle BCI test in FIG. 3), a wire harness connected to a DUT is injected with a noise signal at one place, with simultaneous interference at any other places ignored. In this way, with a conventional measured benchmark, a DUT is tested alone, and this is one of the causes of unsatisfactory reproduction of EMC interference that occurs on a real vehicle.

Moreover, as mentioned earlier, in conventional computer simulation, it is necessary to analyze on a three-dimensional level a wire harness network on a vehicle to perform electromagnetic simulation (FIG. 18A). This electromagnetic simulation requires highly intensive arithmetic operation and, even when focused on one noise injection point, takes several tens of hours to several hundred hours of processing time. Thus, reproducing simultaneous multiple injection of a noise signal by conventional computer simulation is impractical from the perspective of processing time (processing performance).

Presented below will be how to construct a simulation model that can reproduce, at low cost and with reasonable processing time, an environment where a transmission line network is interfered at a plurality of places, based on the novel method of computer simulation described thus far (i.e., the method of evaluating the immunity characteristics of a device-under-test using a transmission line model that models a transmission line connected to the device-under-test).

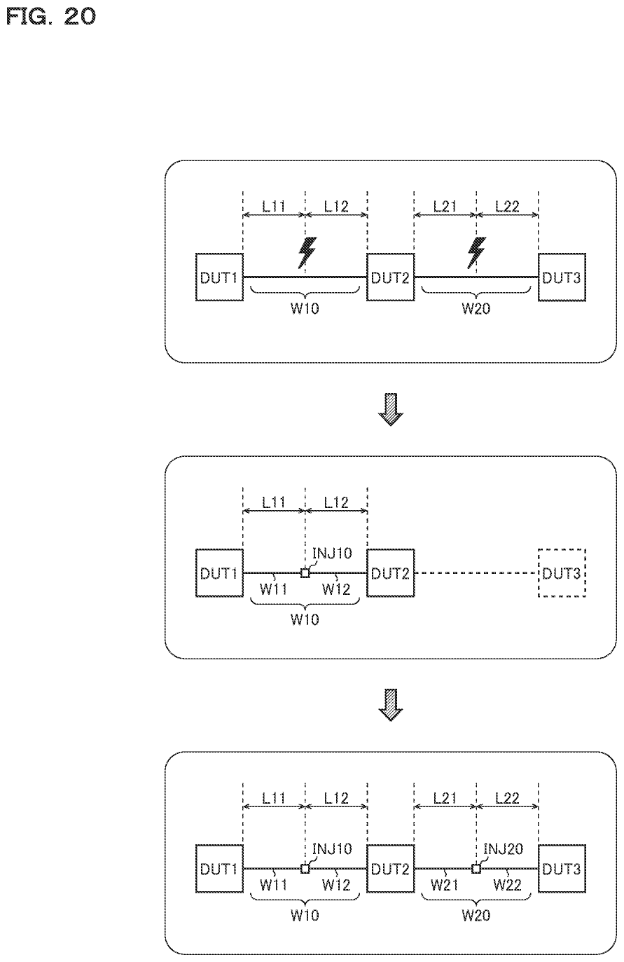

FIG. 20 is a schematic diagram showing a first example of a simultaneous multiple injection model. The top pain of the figure schematically depicts a structure that will be modeled. The middle pain of the figure depicts a conventional single-point injection model, and the bottom pain of the figure depicts a first example of a simultaneous multiple injection model presented herein.

The structure in the top pain in FIG. 20 includes three devices-under-test DUT1 to DUT3 and two wires W10 and W20 independent of each other. The wire W10 is a transmission line connecting between the devices-under-test DUT1 and DUT2, and is laid without being bent between the two devices. Likewise, the wire W20 is a transmission line connecting between the devices-under-test DUT2 and DUT3, and is laid without being bent between the two devices. While in the top pane in the diagram the devices-under-test DUT1 to DUT3 are disposed along a straight line, this is not meant to limit their layout. It can be understood that a noise current is injected into a good-conductor surface (such as the body of a vehicle, or an internal structure of a vehicle that is electrically a ground plane but that is difficult to classify as the body of the vehicle) that serves as the ground plane for either or both of the wires W10 and W20. The wires W10 and W20 can each be understood to be replaceable with a wire harness (a bundle of a plurality of wires).

When the structure described above is exposed to EMC interference (e.g., when the vehicle is exposed to a thunderbolt), the wires W10 and W20 are interfered simultaneously. The top pane of FIG. 20 depicts interference occurring simultaneously at one point on the wire W10 (the point at a distance of L11 from the device-under-test DUT1 and at a distance of L12 from the device-under-test DUT2) and at one place on the wire W20 (the point at a distance of L21 from the device-under-test DUT2 and at a distance of L22 from the device-under-test DUT3).

In modeling the structure above, with a conventional single-point injection model (middle pane of FIG. 20), only the wire W10 has a noise injection point INJ10 set on it, and simultaneous interference on the wire W20 is ignored (see the broken lines).

By contrast, with a simultaneous multiple injection model presented herein (lower pane of FIG. 20), the wires W10 and W20 each have a noise injection point INJ10 or INJ20 set on it, and a noise signal is injected at each of them simultaneously.

The noise injection point INJ10 is set such that, of the wire W10 (total length: L11+L12), the part laid between the device-under-test DUT1 and the noise injection point INJ10 is understood as a division wire W11 (length: L11) and the part laid between the noise injection point INJ10 and the device-under-test DUT2 is understood as a division wire W12 (length: L12).

Likewise, the noise injection point INJ20 is set such that, of the wire W20 (total length: L21+L22), the part laid between the device-under-test DUT2 and the noise injection point INJ20 is understood as a division wire W21 (length: L21) and the part laid between the noise injection point INJ20 and the device-under-test DUT3 is understood as a division wire W22 (length: L22).

As for the transmission line models which model the division wires W11 and W12 and the division wires W21 and W22 respectively, they can be created, as described thus far, to include as parameters representing their transmission characteristics a characteristic impedance Z0 and a delay time TD.

Incidentally, their characteristic impedances Z0 can be set according to the arrangement or type of the division wires W11 and W12 and the division wires W21 and W22 respectively. For example, the transmission line models can be classified into at least two types, namely end-line and middle-line models, which are given different values as their characteristic impedances Z0.

On the other hand, their delay times TD can be set according to the total length or type of the wire W10, or the positions of the noise injection points INJ10 and INJ20 (i.e., the lengths of the division wires W11 and W12 and the lengths of the division wires W21 and W22).

Of the devices-under-test DUT1 to DUT3, for the device-under-test DUT2 in particular, to which the wires W10 and W20 are both connected, its description can include S parameters for two ports to express it as an equivalent circuit having a first port to which the wire W10 is connected and a second port to which the wire W20 is connected.

As mentioned above, with the simultaneous multiple injection model presented herein, the wires W10 and W20 are described as transmission line models and their respective coupling points are connected together with an equivalent circuit; this preliminarily determines the transmission line network as the target of evaluation. Moreover, the wires W10 and W20 have the noise injection points INJ10 and INJ20 respectively set on them, and during computer simulation, a noise signal is injected to the noise injection points INJ10 and INJ20 simultaneously.

With this method, without the need for expensive EMC test equipment or heavy-load electromagnetic simulation, it is possible to reproduce, at low cost and with reasonable processing time, an environment where a transmission line network is interfered simultaneously at a plurality of places. It is thus possible, for example, to correctly evaluate EMC interference that occurs on a real vehicle, and to optimize the layout scheme of a wire harness network. It is then possible to produce a vehicle provided with a wire harness network with a layout scheme evaluated and optimized by the method.

Moreover, the structure of a vehicle imposes restrictions on the laying lengths and paths of wire harnesses. With those taken as conditions, it is possible the extract, out of a number of wire harnesses laid around the vehicle, a group of wire harnesses that are interfered simultaneously (i.e., the wire harnesses to be modeled). It is thus possible to perform computer simulation without excessive burden of arithmetic operation.

For the noise signals that are injected at the noise injection points INJ10 and INJ20 respectively, their parameters (current value (i.e., intensity), frequency, waveform, and the like) can be given variable values so that, while those parameters are adjusted or swept, the immunity characteristics of the devices-under-test DUT1 and DUT2 are evaluated. With an evaluation method like this, it is possible to set, in a simulating manner, magnetic fields applied to the wires W10 and W20 from different angles.

For example, by using as a noise signal not a sinusoidal wave but an impulse and varying the current value of the noise signal injected at each of the noise injection points INJ10 and INJ20 as necessary, it is possible to correctly verify the effect of magnetic fields applied from different angles to a vehicle exposed to a thunderbolt. Through the following description, by way of a second example of a simultaneous multiple injection model, a method of evaluating the effect of a natural phenomenon such as a thunderbolt will be presented.

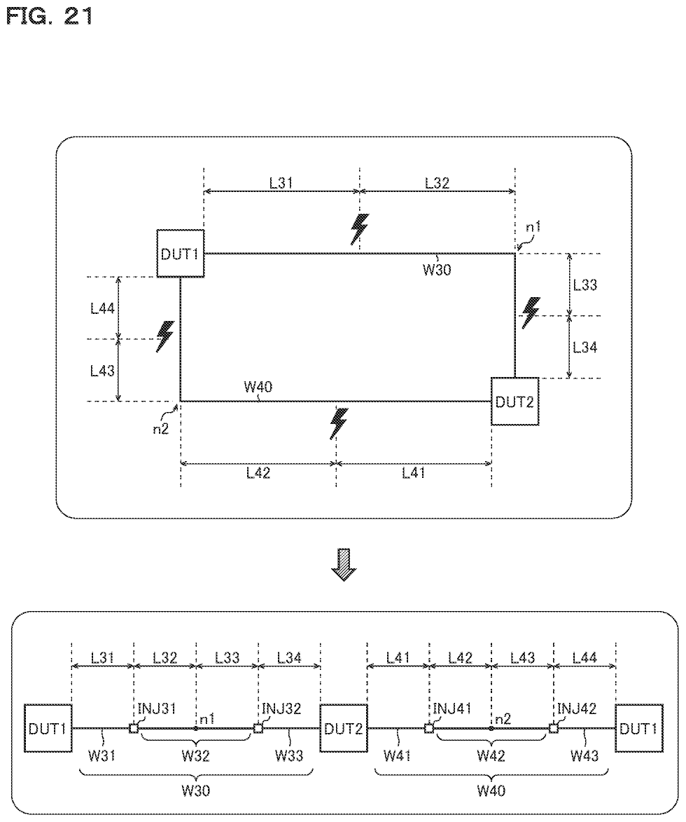

FIG. 21 is a schematic diagram showing a second example of a simultaneous multiple injection model. The upper pane of the diagram schematically depicts a structure to be modeled, and the lower pane of the diagram depicts the second example of the simultaneous multiple injection model presented herein.

The structure in the upper pane of FIG. 21 includes two devices-under-test DUT1 and DUT2 and two wires W30 and W40 independent of each other. The wire W30 is a transmission line that connects between the devices-under-test DUT1 and DUT2, and is laid so as to bend at 90° at a node n1 between the two devices. Likewise, the wire W40 is a transmission line that connects between the devices-under-test DUT1 and DUT2, and is laid so as to bend at 90° at a node n2 between the two devices.

As described above, the upper pane of FIG. 21 depicts, as the simplest structure for evaluation of the effect of a natural phenomenon such as a thunderbolt, a rectangular loop structure (hereinafter referred to as a wire loop) formed by the wires W30 and W40.

While in the upper pane of FIG. 21 the wires W30 and W40 are each bent at 90°, this is not meant to limit the angle. It can also be understood that a noise current is injected into a good-conductor surface (such as a body) that acts as a ground plane for either or both of the wires W30 and W40. The wires W30 and W40 can each be understood to be replaceable with a wire harness (a bundle of a plurality of wires).

When the above structure is exposed to EMC interference (e.g., when the vehicle is exposed to a thunderbolt), the wires W30 and W40 are both interfered simultaneously. The wire W30 is bent at the node n1, and is disposed in different directions in its parts corresponding to the top and right sides of the wire loop, those parts being interfered by EMC interference differently. The same applies to the wire W40, its parts corresponding to the bottom and left sides of the wire loop being interfered by EMC interference differently.

In view of that, the upper pane of FIG. 21 depicts a case where interference is inflicted at each of two points on the wire W30 (a point on the top side of the wire loop at a distance of L31from the device-under-test DUT1 and at a distance of L32 from the node n1 and a point on the right side of the wire loop at a distance of L33 from the node n1 and at a distance of L34 from the device-under-test DUT2) and two points on the wire W40 (a point on the bottom side of the wire loop at a distance of L41 from the device-under-test DUT2 and at a distance of L42 from the node n2 and a point on the left side of the wire loop at a distance of L43 from the node n2 and at a distance of L44 from the device-under-test DUT1).

In modeling the above structure, the simultaneous multiple injection model presented herein (lower pane of FIG. 21) has two noise injection points on each wire, namely noise injection points INJ31 and INJ32 on the wire W30 and noise injection points INJ41 and INJ42 on the wire W40, and a noise signal is injected at each of those noise injection points simultaneously.

The noise injection points INJ31 and INJ32 are set as follows: of the wire W30 (total length: L31+L32+L33+L34), the part laid between the device-under-test DUT1 and the noise injection point INJ31 can be understood as a division wire W31 (length: L31), the part laid from the noise injection point INJ31 via the node n1 to the noise injection point INJ32 can be understood as a division wire W32 (length: L32+L33), and the part laid between the noise injection point INJ32 and the device-under-test DUT2 can be understood as a division wire W33 (length: L34).

Likewise, the noise injection points INJ41 and INJ42 are set as follows: of the wire W40 (total length: L41+L42+L43+L44), the part laid between the device-under-test DUT2 and the noise injection point INJ41 can be understood as a division wire W41 (length: L41), the part laid from the noise injection point INJ41 via the node n2 to the noise injection point INJ42 can be understood as a division wire W42 (length: L42+L43), and the part laid between the noise injection point INJ42 and the device-under-test DUT1 can be understood as a division wire W43 (length: L44).

Setting a plurality of noise injection points on a single wire in this way makes it possible to express how the wire is bent (where and in what direction it is bent) simply by changing the lengths of division wires and the parameters of the noise signal without changing the description of a transmission line model itself. It is thus possible to freely model transmission line networks with varying layouts. For example, it is possible to appropriately cope with cases where the strength of the interfering wave depends on the structure of a vehicle.

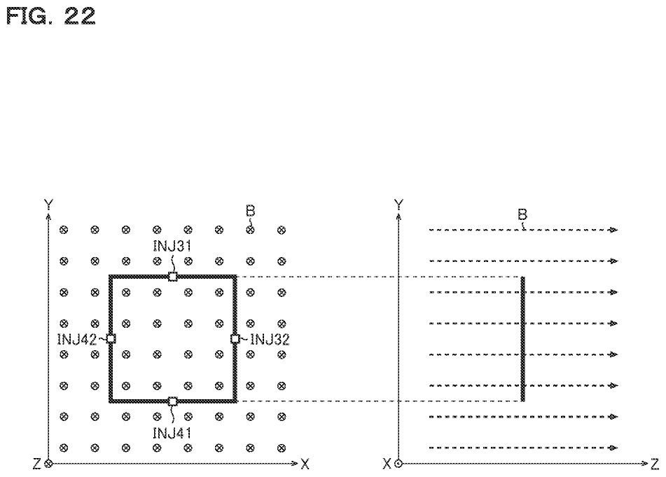

FIG. 22 is a schematic diagram showing a situation where a magnetic field B is applied in the direction perpendicular to the opening of the wire loop shown in FIG. 21 (a situation where the wire loop has the maximum effective sectional area). The left part of the figure is a schematic diagram (a view on the XY plane) of the wire loop in FIG. 21 as seen from the Z-axis direction. The right part of the figure is a schematic diagram (a view on the YZ plane) of the wire loop in FIG. 21 as seen from the X-axis direction.

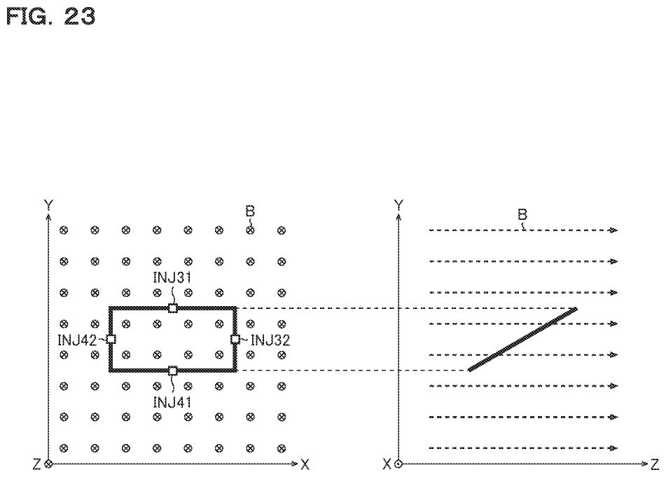

On the other hand, FIG. 23 is a schematic diagram showing a situation where a magnetic field B is applied in a direction oblique to the opening of the wire loop in FIG. 21 (i.e., a situation where the wire loop is inclined in the Z-axis direction and has a reduced effective sectional area from FIG. 22). The left part of the figure is a schematic diagram (a view on the XY plane) of the wire loop in FIG. 21 as seen from the Z-axis direction. The right part of the figure is a schematic diagram (a view on the YZ plane) of the wire loop in FIG. 21 as seen from the X-axis direction.

The difference between FIGS. 22 and 23 can be understood to result from the wire loop being rotated while the magnetic field B is being applied to it in a fixed direction, or can be understood to result from the direction of application of the magnetic field B being rotated with respect to the wire loop kept at a fixed position.

As will be understood from a comparison of the two diagrams, the strength of the noise signal injected in the top and bottom sides of the wire loop (which is equivalent to the number of magnetic lines penetrating the wires on which the noise injection points INJ31 and INJ41 are respectively provided) remains constant irrespective of the application direction of the magnetic field B. On the other hand, the strength of the noise signal injected in the left and right sides of the wire loop (which is equivalent to the number of magnetic lines penetrating the wires on which the noise injection points INJ32 and INJ42 are provided) diminishes as the effective sectional area of the wire loop decreases.

In view of the foregoing, for example, by reducing the noise strength at the noise injection points INJ32 and INJ42 while keeping the noise strength at the noise injection points INJ31 and INJ41, it is possible to reproduce a situation where the wire loop is inclined in the Z-axis direction. Likewise, by appropriately adjusting the noise strength at each noise injection point, it is possible to freely reproduce situations where the magnetic field B is applied to the wire loop from any directions.

Moreover, by appropriately adjusting the noise strength at each noise injection point, it is even possible to freely reproduce situations where the currents induced respectively at the top and bottom sides of a wire loop, or the currents induced respectively at the left and right sides of a wire loop, strengthen or weaken each other.

Thus, by adopting the second example (FIG. 21) of a simultaneous multiple injection model and appropriately adjusting the position, path, strength, frequency, and waveform of the interference inflicted on a wire harness, it is possible to properly evaluate, even with a natural phenomenon (such as a thunderbolt) of which the interference conditions cannot be determined unless it actually occurs, its effect on a structure (such as a vehicle). Accordingly, reflecting the results of such evaluation in prior designing contributes to improved reliability. It is thus possible to manufacture a vehicle with improved reliability of which the design reflects evaluation conducted by the method described above.

Incidentally, for the respective terminal nodes of the wires W30 and W40 in FIG. 21 (i.e., in the diagram, the connection nodes with the devices-under-test DUT1 and DUT2), programming can be done such that the impedance at each of them can be set in the range of 0 to ∞ (infinity). Setting such a range makes it possible to express not only a closed loop but also an open loop in equivalent terms.

<Introducing a Characteristic Change Node>

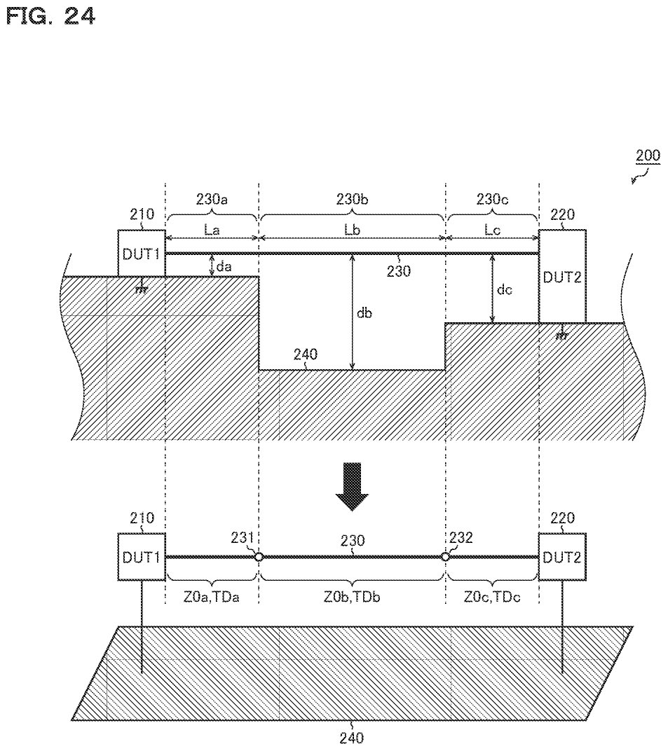

FIG. 24 is a schematic diagram showing the modeling of a wire laid near a good-conductor surface. In the diagram, a structure 200 (such as a vehicle) includes devices-under-test 210 and 220 (e.g., a driver and a receiver), a wire 230, and a good-conductor surface 240 (such as a body).

The devices-under-test 210 and 220 have their respective reference potential terminals (ground terminals) connected to the good-conductor surface 240. This type of connection (what is called local grounding) is widely adopted in low-cost vehicle onboard appliances.

It should however be noted that the reference potential terminals (ground terminals) of the devices-under-test 210 and 220 do not necessarily have to be connected to the good-conductor surface 240. For example, in ordinary electrical components, it is common to use a chassis (case) for local grounding and to connect the reference potential terminal (ground terminal) of an electric circuit to a GND wire harness. In cases where a shielded wire harness is used, it is common to connect the shield to a chassis (case).

The wire 230 is a transmission line for connecting between the devices-under-test 210 and 220. As shown in FIG. 24, the wire 230 is generally laid near the good-conductor surface 240, which serves as a ground plane for it.

As described above, in the structure 200, the devices-under-test 210 and 220, the wire 230, and the good-conductor surface 240 serving as a ground plane for them constitute a continuous loop structure. In other words, the just-mentioned continuous loop structure includes, as part of the transmission line constituting it, a ground plane. This can be understood as a structure where, as compared with what is shown in FIG. 21, the wire W40 mentioned previously is replaced with the good-conductor surface 240 or the good-conductor surface 240 functions as a quasi-wire.

Moreover, it is widely known that, in a case where a continuous loop structure is formed as described above, the magnetic flux passing through the opening produces a common-mode loop current. On the other hand, if at least either of the devices-under-test 210 and 220 is not locally grounded, no loop current as mentioned above is produced, and the wire 230 is, as a monopole antenna, exposed to noise.

Incidentally, in a case where the wire 230 is laid near a good-conductor surface 240 with surface irregularities, the parameters (such as the characteristic impedance Z0 and the delay time TD) that represent the transmission characteristics of the wire 230 vary from place to place according to the positional relationship (distance) between the wire 230 and the good-conductor surface 240 and are not necessarily uniform everywhere.

For example, in terms of what is shown in FIG. 24, one wire 230 can be divided into three parts 230a, 230b, and 230c (with wire lengths La, Lb, and Lc respectively), in which case the distance between the part 230a and the good-conductor surface 240 is da, the distance between the part 230b and the good-conductor surface 240 is db, and the distance between the part 230c and the good-conductor surface 240 is dc (e.g., da<dc<db).

Thus, for example, it can be said that the characteristic impedance Z0a and the delay time TDa of the part 230a should preferably be set according to the distance da and the wire length La. Likewise, it is preferable that the characteristic impedance Z0b and the delay time TDb of the part 230b should preferably be set according to the distance db and the wire length Lb and that the characteristic impedance Z0c and the delay time TDc of the part 230c should preferably be set according to the distance dc and the wire length Lc.

As described above, a wire 230 laid near a good-conductor surface 240 with surface irregularities has a point at which the parameters that represent its transmission characteristics change midway. Put the other way around, if such changes in characteristics can be modeled properly, it is then possible to express a good-conductor surface 240 that acts as a quasi-wire constituting part of a loop structure.

Accordingly, in a novel transmission line model in the lower part of FIG. 24, so that the above-mentioned parts 230a, 230b, and 230c may each be assigned parameters separately, the single wire 230 includes at least one, and in FIG. 24 two, parameter change nodes 231 and 232.

With a transmission line model like this, it is possible to correctly express midway changes in the parameters that represent the transmission characteristics of the wire 230.

For the characteristic change nodes 231 and 232, as with the terminal nodes mentioned above, programming can be done such that the impedance at each of them can be set in the range of 0 to ∞ (infinity).

For example, by setting a number of characteristic change nodes and appropriately setting the impedance at each of them in the range from 0 to ∞ and in addition appropriately setting parameters for each of the parts divided at those characteristic change nodes, it is possible, whatever shape the good-conductor surface 240 may have, to accurately simulate the behavior of a wire 230 laid near it, and hence to correctly evaluate the immunity characteristics of each of the devices-under-test 210 and 220.

<Introducing Branch Nodes>

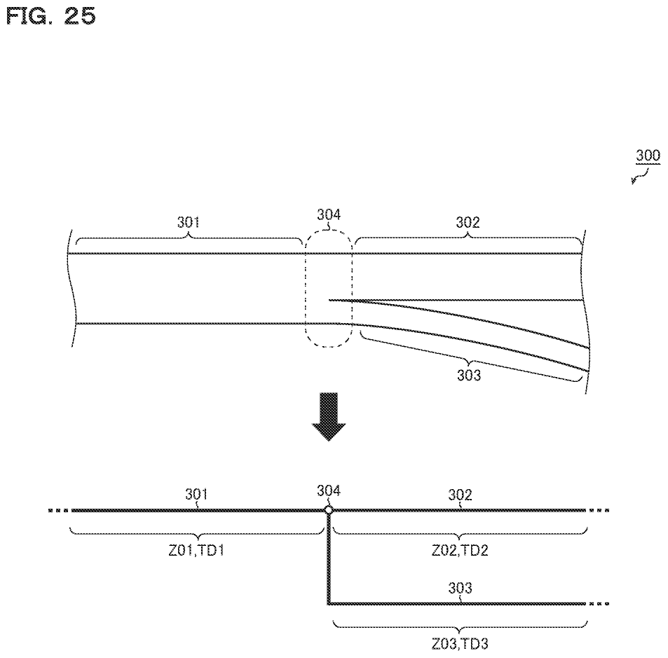

FIG. 25 is a schematic diagram showing the modeling of a wire harness with a bifurcated structure. In the diagram, a wire harness 300 (a plurality of wires bundled into one cable) has a main line 301, branch lines 302 and 303, and a bifurcation 304. More specifically, at the bifurcation 304 on the wire harness 300, a part of the main line 301 branches off as the branch line 302 and another part of it branches off as the branch line 303.

Accordingly, a novel transmission line model in the lower part of FIG. 25 includes, as a node corresponding to the bifurcation 304 mentioned above, a bifurcation node 304 at which the main line 301 and the branch lines 302 and 303 of the wire harness 300 are connected together.

With a transmission line model like this, it is possible to separately set the parameters (Z01 and T1) that represent the transmission characteristics of the main line 301 and the parameters (Z02 and TD2 as well as Z03 and TD3) that represent the transmission characteristics of the branch lines 302 and 303 respectively. It is thus possible to correctly express the bifurcated structure of the wire harness 300.

While FIG. 25 shows a structure where the main line 301 of the wire harness 300 branches into two branch lines 302 and 303, the number of branches may be three or more.

<Determining a Noise Injection Position>

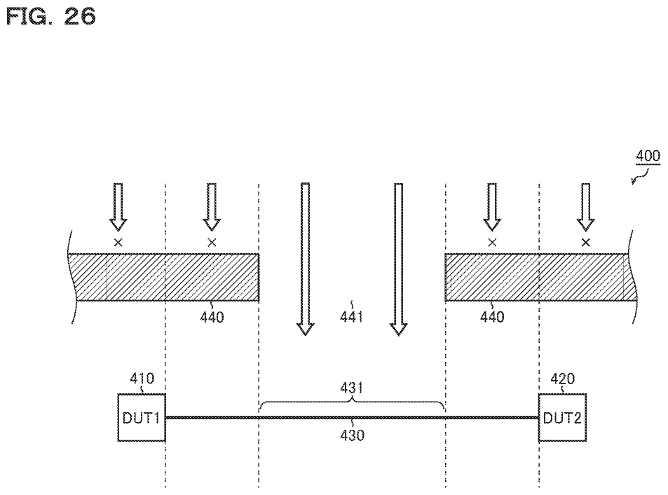

FIG. 26 is a diagram showing a noise injection position at which noise is injected into a wire laid inside a structure (e.g., vehicle). In the diagram, a structure 400 includes, inside it, devices-under-test 410 and 420 and a wire 430.

In general, a body 440 of the structure 400 is formed of a good conductor such as metal. Accordingly, the electromagnetic waves (see hollow arrows) that reach the structure 400 from the outside are mostly attenuated by the body 440. That is, the body 440 functions as an electromagnetic wave shielding member.

In general, however, the body 440 has an opening 441 formed in it to accommodate a window pane (front, rear, side, etc.). Compared with the body 440, formed of a good conductor, such an opening 441 has significantly lower (or no) electromagnetic wave shielding power. Thus, electromagnetic waves enter the structure 400 mainly through the opening 441.

In view of the foregoing, when determining a noise injection position on the wire 430, it is reasonable to grasp, in addition to the direction from which electromagnetic waves strike the structure 400, the position, size, shape, and the like of the opening 441.

For example, take the wire 430 laid between the devices-under-test 410 and 420: an unshielded part 431 of it (the part facing the opening 441), which is not shielded by the body 440, is considered to be where electromagnetic waves are likely to reach the wire 430 without being intercepted. Accordingly, it is considered to be appropriate to assign the above-mentioned noise injection point (like the noise injection point INJ1 in FIG. 15) to the unshielded part 431 of the wire 430.

In FIG. 26, for the sake of simple illustration, the unshielded part 431 of the wire 430 is shown to have the same width as the opening 441 in the body 440; in reality, however, since electromagnetic waves are refracted according to their wavelengths, those widths are not always equal. Even so, the unshielded part 431 of the wire 430 invariably depends on the opening 441 in the body 440, and this solidifies the above conclusion that the unshielded part 431 is suitable as a noise injection position.

<Sensitivity to Electromagnetic Waves of Different Parts of a Structure>

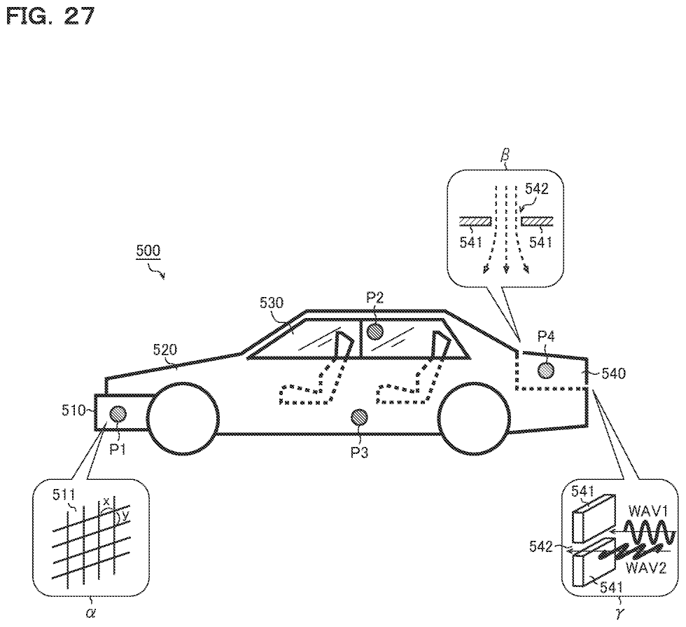

FIG. 27 is a schematic diagram illustrating how different parts of a structure differ in sensitivity to electromagnetic waves. For example, in terms of what is shown there, consider a case where a structure 500 is a vehicle. In this case, parts P1 to P4 of the structure 500 differ in sensitivity to electromagnetic waves.

More specifically, part P1, which is covered by a bumper 410 made of resin, is more susceptible to electromagnetic waves than parts P2 to P4, which are covered by a body 520, which is a good conductor. Accordingly, when a transmission line laid in part P1 is modeled, it is preferable to set the strength of noise injected at a noise injection point on the transmission line comparatively high.

Incidentally, for example, by providing a metal mesh shield 511 at part P1, it is possible to reduce the sensitivity of part P1 to electromagnetic waves (see balloon α). It should however be noted that electromagnetic waves with wavelengths of the mesh size (horizontally x, vertically y) or less penetrate the mesh shield 511.

Also for parts P2 to P4, the sensitivity for electromagnetic waves there is not uniform. For example, part p2, which is close to a window 530, is considered to be more susceptible to electromagnetic waves than part P3, under seats, and part P4, inside a trunk.

The trunk 540 is tightly closed with an electromagnetic wave shielding member 541 (the body and the trunk lid), and thus part P4 appears to be hardly susceptible to electromagnetic waves. In reality, however, experiments have brought a finding that even part P4 is susceptible to electromagnetic waves that leak by diffraction at a gap 542 (see balloon β).

It is considered that, with respect to the direction in which the slit at the gap 542 extends, electromagnetic waves WAV1 of which the direction of oscillation is not parallel to it are unlikely to enter, while electromagnetic waves WAV2 of which the direction of oscillation is parallel to it are likely to enter (see balloon γ).

<Electromagnetic Wave Incidence Direction>

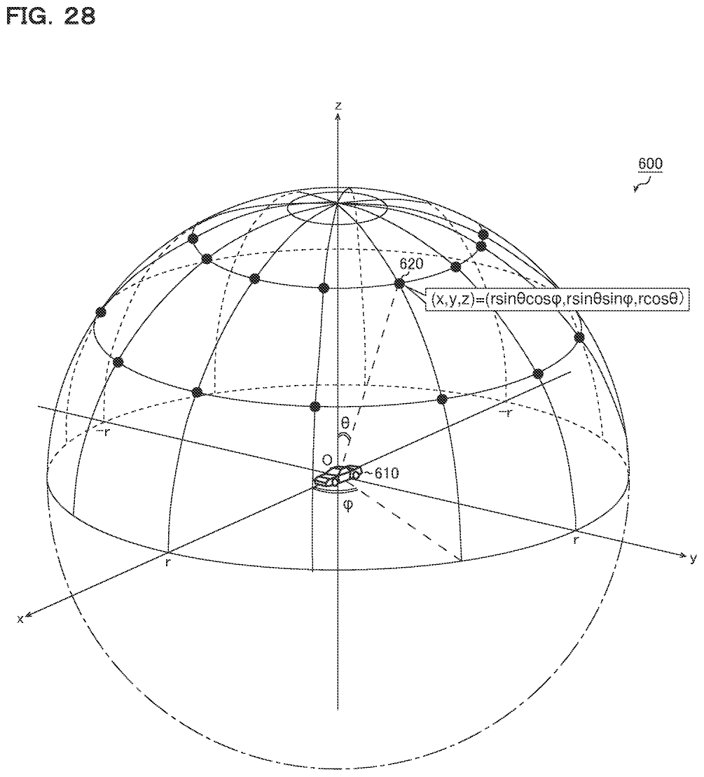

FIG. 28 is a schematic diagram showing a plurality of electromagnetic wave sources provided around a structure. In determining a noise injection position on a transmission line model laid in a structure, it is necessary to consider the direction of incidence of electromagnetic waves with respect to the structure.

Accordingly, in a simulation model 600 in the diagram, a spherical coordinate system (r, θ, φ) with an origin O at a structure 610 (e.g., vehicle) is set, and a plurality of electromagnetic wave sources 620 are disposed on a hemisphere (or a whole sphere) with a radius of r that surrounds the structure 610. That is, the plurality of electromagnetic wave sources 620 are disposed at equal distances from, in different directions from, the structure 610. The frequency and strength of the electromagnetic waves emitted from the plurality of electromagnetic wave source 620 can be set uniformly.

The first angular coordinate θ is the angle formed between the z axis of a rectangular coordinate system (x, y, z) and a radius, and the range of its variation is −π/2≤θ≤π/2 (in the case of a hemisphere).

The second angular coordinate φ is the angle formed between the x axis of a rectangular coordinate system (x, y, z) and the projection of the radius on the xy plane, and the range of its variation is 0≤φ≤2π.

Conversion from a spherical coordinate system (r, θ, φ) to a rectangular coordinate system (x, y, z) is possible according to (x, y, z)=(r sin θ cos φ, r sin θ sin φ, r cos θ).

While in FIG. 28 the plurality of electromagnetic wave sources 620 are disposed on a hemisphere, in a case where the structure 610 is likely to be exposed to electromagnetic waves from below (e.g., in a case where an electric vehicle is supplied with electric power on a non-contact basis by electromagnetic waves from a road surface), the plurality of electromagnetic wave source 620 can be disposed on a whole sphere. In that case, the range of the variation of the first angular coordinate can be −π/2≤θ≤π.

In FIG. 28, for the sake of simple description, a single spherical coordinate system is shown. Instead, for simulation of the effect of multiple noise incident from a plurality of electromagnetic wave sources, a plurality of spherical coordinate systems may be used.

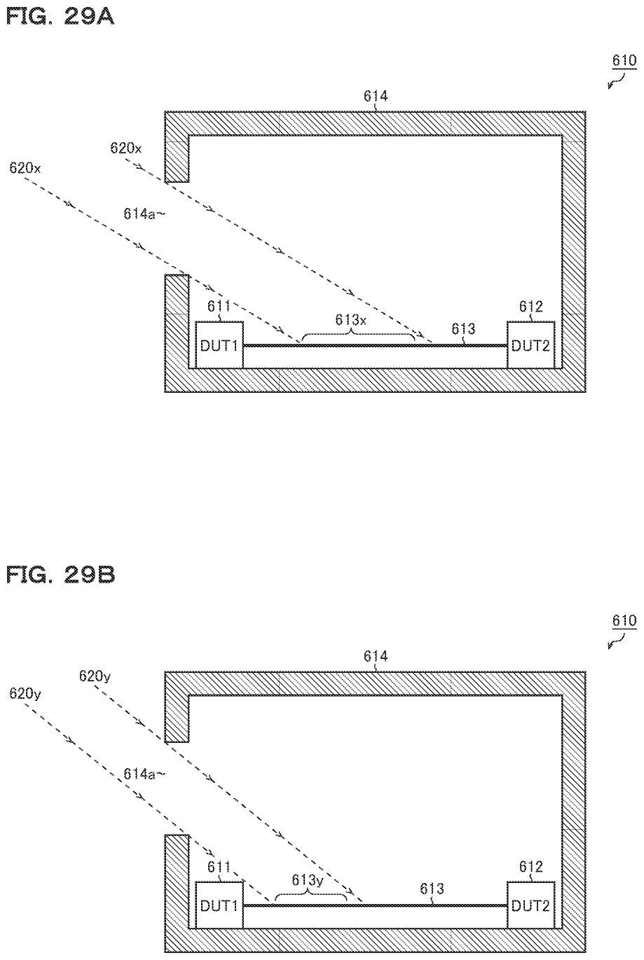

FIGS. 29A and 29B are schematic diagrams respectively showing noise injection positions with different electromagnetic wave sources selected. In each diagram, a structure 610 includes, inside it, devices-under-test 611 and 612 and a wire 613.

The electromagnetic waves from the electromagnetic wave sources 620x and 620y (each corresponding to one of the electromagnetic wave sources 620 in FIG. 28) provided around the structure 610 are mostly attenuated by a body 614, which is a good conductor. That is, the body 614 functions as an electromagnetic wave shielding member.

The body 614, however, has an opening 614a, which has low electromagnetic wave shielding power; thus, electromagnetic waves enter the structure 610 mainly through the opening 614a. Here, according to which of the electromagnetic wave sources 620x and 620y is selected, the part of the wire 613 that is effected by the electromagnetic waves changes.

For example, when as shown in FIG. 29A electromagnetic waves are emitted from the electromagnetic wave source 620x, it can be said that the electromagnetic waves are likely to reach an unshielded part 613x that is visible through the opening 614a from the electromagnetic wave incidence direction.

By contrast, when as shown in FIG. 29B electromagnetic waves are emitted from the electromagnetic wave source 620y, as the electromagnetic wave incidence direction changes, the unshielded part 613y that is visible through the opening 614a changes.

Accordingly, when determining a noise injection position on the wire 613, it is reasonable to grasp not only the electromagnetic wave incidence direction with respect to the structure 610 but also the position, size, shape, and the like of the opening 614a.

To that end, use can be made of three-dimensional data of the structure 610 and the wire 613 (e.g., three-dimensional CAD [computer-aided design] data that describes structural information on the body 614 and layout route information on the wire 613 respectively); it is preferable to thereby grasp what part of the wire 613 is affected by electromagnetic waves incident from a given direction and then accordingly set a noise injection position, a noise injection strength, and the like.

In FIGS. 29A and 29B, for the sake of simple description, a single noise injection position is determined with respect to a single wire 613; in an actual simulation, the immunity characteristics of a device-under-test are evaluated not with a noise injection point set at one specific place but with a noise signal injected simultaneously at a plurality of noise injection points set at different places along a wire harness network.

<Omnidirectional Simulation>

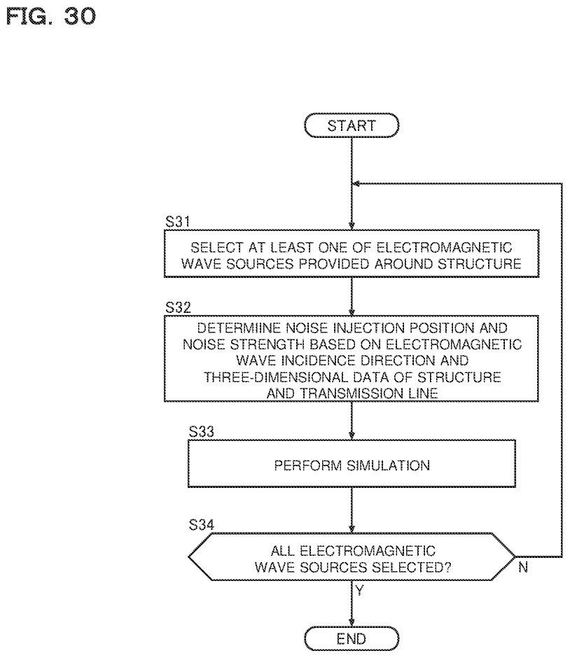

FIG. 30 is a flow chart showing one example of an omnidirectional simulation. The flow proceeds as follows. At step S31, at least one of a plurality of electromagnetic wave sources disposed around a structure (e.g., vehicle) provided with a transmission line is selected (see FIG. 28). That is, at step S31, one electromagnetic wave incidence direction with respect to the structure is selected.

Next, at step S32, based on the electromagnetic wave incidence direction with respect to the structure (i.e., coordinate information indicating the position of the electromagnetic wave source) and the three-dimensional data of each of the structure and the transmission line, at least one of a noise injection position or a noise strength on the transmission line is determined (see FIGS. 29A and 29B).

Next, at step S33, using a transmission line model that reflects the various parameters at step S32, a transmission line simulation as described thus far is performed, and thereby the immunity characteristics of a device-under-test connected to the transmission line is evaluated.

Next, at step S34, whether all the electromagnetic wave sources have been selected is checked. If the result is “yes”, the flow described above ends. By contrast, if the result is “no”, the flow returns to step S31, where the electromagnetic wave source 620 (hence the electromagnetic wave incidence direction) is changed.

Thus, through an omnidirectional simulation along the flow described above, it is possible to correctly simulate the effect of electromagnetic waves that reach a structure from different directions.

<Modifications>

The various technical features disclosed herein may be implemented in any manners other than in the embodiments described above, and allow for many modifications without departure from the spirit of their technical ingenuity. That is, the embodiments described above should be understood to be in every aspect illustrative and not restrictive, and the technical scope of the present invention is defined not by the description of the embodiments given above but by the appended claims and encompasses any modifications within a scope and sense equivalent to those claims.

### INDUSTRIAL APPLICABILITY

The invention disclosed herein finds application in EMC computer simulation for evaluation of immunity characteristics or emission characteristics of structures (vehicles, railway cars, marine vessels, aircraft, and the like) that have conductive wire harnesses. The invention is also useful in manufacturing structures (vehicles, railway cars, marine vessels, aircraft, and the like) that have conductive wire harnesses that are evaluated by simulation for optimization.

### REFERENCE SIGNS LIST

10 device-under-test (DUT)
11 LSI
20 noise source
21 signal generator
22 RF amplifier
23 bidirectional coupler
24 traveling wave-side power sensor
25 reflected wave-side power sensor
26 power meter
28 50Ω transmission line
30 detector (e.g., oscillator)
40 controller (e.g., personal computer)
50 battery
60 power filter
61, 62 power impedance stabilization networks (LISN)
70 wire harness
80 injection probe
90 antenna
91 terminal
100 test target circuit unit
200 structure
210, 220 device-under-test
230 wire
231, 232 characteristic change node
240 good-conductor surface
300 wire harness
301 main line
302, 303 branch line
304 bifurcation (bifurcation node)
400 structure
410, 420 devices-under-test
430 wire
440 body (electromagnetic wave shielding member)
441 opening
500 structure (vehicle)
510 mesh shield
520 body (electromagnetic wave shielding member)
530 window
540 trunk
541 electromagnetic wave shielding member
542 gap
600 simulation model
610 structure (vehicle)
611, 612 device-under-test
613 wire
614 body (electromagnetic wave shielding member)
614a opening
620 electromagnetic wave source
A simulation model
A1 battery/LISN model
A2 DUT model
A3 BCI injection probe model
A4 wire harness model (transmission line model)
B magnetic field
c1 inner conductor
c2 outer conductor
DUT1, DUT2, DUT3 devices-under-test
INJ1, INJ2, INJ10, INJ20, INJ31, INJ32, INJ41, INJ42 noise injection point
SIG1, SIG2 signal node
w1 to w6, W, W10, W20, W30, W40 wire
W1 to W5, W11, W12, W21, W22, W31 to W33, W41 to W43 division wire
wh, wh11 to wh15, wh21 to wh24 wire harness
X vehicle
X1 battery
X2 ECU
X3 wire harness

1. A method of computer simulation for evaluating immunity characteristics of a device-under-test comprising:
using a transmission line model that models a transmission line connected to the device-under-test, wherein the transmission line model includes a characteristic change node at which parameters representing transmission characteristics of the transmission line change midway.

2. The method according to claim 1, wherein the characteristic change node is set on a single transmission line.

3. The method according to claim 1, wherein the parameters representing the transmission characteristics are set according to a positional relationship between the transmission line and a ground plane.

4. The method according to claim 1, wherein the parameters representing the transmission characteristics include a characteristic impedance and a delay time.

5. The method according to claim 1, wherein a loop structure formed by the device-under-test and the transmission line includes a ground plane as part of the transmission line.

6. The method according to claim 1, wherein an impedance at each of a terminal node and the characteristic change node of the transmission line model can be set in a range from zero to infinity.

7. The method according to claim 1, wherein the transmission line model includes a bifurcating node at which a main part and a plurality of branch parts of the transmission line are connected together.

8. A method of computer simulation, comprising:
determining at least one of a noise injection position or a noise strength on a transmission line based on
an electromagnetic wave incidence direction with respect to a structure that incorporates the transmission line, and
three-dimensional data of each of the structure and the transmission line; and
evaluating immunity characteristics of a device-under-test connected to the transmission line by use of a transmission line model that models the transmission line.

9. The method according to claim 8, wherein the three-dimensional data includes structure information on an electromagnetic wave shielding member that forms the structure.

10. The method according to claim 8, further comprising:
changing the electromagnetic wave incidence direction by selecting at least one of a plurality of electromagnetic wave sources provided around the structure.

11. The method according to claim 10, wherein the plurality of electromagnetic wave sources are disposed at equal distances from, and in different directions from, the structure.

12. The method according to claim 1, wherein the transmission line constitutes a wire harness laid in a vehicle, railway car, marine vessel, or aircraft.

13. A device set, comprising:
a device connected to a transmission line; and
a data provider configured to provide data on a transmission line model for testing the device in the transmission line,
wherein
the data on the transmission line model includes data on a characteristic change node at which parameters representing transmission characteristics of the transmission line change midway across the transmission line.
